(19) United States
(12) Patent Application Publication
(10) Pub. No.: US 2024/0290992 A1
(43) Pub. Date: Aug. 29, 2024

(54) CONFORMAL COATING SCAFFOLD ELECTRODES FOR REVERSIBLE SOLID OXIDE CELLS

(71) Applicant: West Virginia University Board of Governors on Behalf of West Virginia University, Morgantown, WV (US)

(72) Inventors: Hanchen Tian, Morgantown, WV (US); Wenyuan Li, Morgantown, WV (US); Xingbo Liu, Morgantown, WV (US)

(21) Appl. No.: 18/586,661

(22) Filed: Feb. 26, 2024

Related U.S. Application Data
(60) Provisional application No. 63/487,044, filed on Feb. 27, 2023.

(51) Int. Cl. H01M 4/90; H01M 4/86; H01M 8/0271

(52) U.S. Cl. CPC H01M 4/9033; H01M 4/8621; H01M 4/8657; H01M 8/0271

(57) ABSTRACT

In one aspect, the disclosure relates to conformal coating scaffold electrodes having a sintered porous perovskite scaffold and a continuous, uniform catalyst coating covering the scaffold. In one aspect the perovskite can have the formula BaZrₓCe_{y}Y_{z}Yb_{(1-x-y-z)}O_{3-δ}, wherein 0.1≤x≤0.8, wherein 0≤y≤0.8, and wherein 0≤z≤0.3, while the catalyst can have the formula Pr₂₋ₓBaₓNiO4_{+δ}, wherein 0≤x≤0.4 (PBNO). The disclosed electrodes exhibit improved long-term operational stability compared to current technology and are sustainable, scalable, and inexpensive to produce. Also disclosed are methods for making the coating, electrochemical cells comprising the electrodes, and devices incorporating the electrochemical cells. This abstract is intended as a scanning tool for purposes of searching in the particular art and is not intended to be limiting of the present disclosure.

### CROSS REFERENCE TO RELATED APPLICATIONS

This application claims the benefit of U.S. Provisional Application No. 63/487,044 filed on Feb. 27, 2023, which is incorporated herein by reference in its entirety.

### STATEMENT REGARDING FEDERALLY SPONSORED RESEARCH OR DEVELOPMENT

This invention was made with government support under contract number DE-EE0008378 awarded by the Office of Energy Efficiency and Renewable Energy of the Department of Energy. The government has certain rights in the invention.

### BACKGROUND

Reversible protonic ceramic electrochemical cells (R-PCECs) have been widely investigated as a promising energy conversion system for long-term and large-scale energy conversion and storage in the past decade. R-PCECs can convert electricity from abundant renewable energy sources to hydrogen fuel with zero carbon emissions (electrolysis cell mode) and then seamlessly convert it to electricity (fuel cell mode). The low cost and high round-trip efficiency reversible operation for R-PCECs provides an attractive alternative to batteries and proton exchange membrane fuel cells. Recent demands for a carbon neutral economy have stimulated great interest in developing robust, inexpensive, and efficient R-PCECs.

Although the successful application of promising Ce-rich BaCe₁₋ₓZrₓO_{3-δ} electrolyte material and triple conducting electrodes (TCOs) have yielded exciting performance in developing PCECs, the commercialization of PCECs is still in the laboratory stage. This is because manufacturing-ready PCECs must fulfill a number of stringent standards, while most of the available materials and strategies in the reported sources cannot meet all of them simultaneously. Apart from the essential requirement of catalytic activity, the electrode and electrolyte should have comparable thermal expansion coefficients to ensure high thermo-mechanical compatibility, high chemical stability, and sufficient thermal cycle durability to ensure long-term operation. The long-term operational stability is equally essential to the catalytic activity, and it determines the commercialization of the PCEC-based devices where neither Ce-rich electrolyte nor TCOs can directly help.

An air-H₂O mixture of high steam concentration (P_{H2O}>20 vol. %) in air electrode is typical under PCEC practical operational conditions, whether the steam is the product of the electricity generation in fuel cell mode or the reactant of hydrogen production in electrolysis mode. This mixture creates significant challenges to the electrode/electrolyte interfacial stability. The Ce-rich BaCe₁₋ₓZrₓO_{3-δ} electrolyte, unfortunately, suffers from susceptibility toward high steam concentration for PCECs, which is predicted by the thermodynamic calculation and confirmed in experimental results. Duan et al. reported BaZr_{0.1}Ce_{0.7}Y_{0.1}Yb_{0.1}O_{3-δ} (BZCYYb1711) based PCECs with a degradation rate of 0.03 mV·h⁻¹ in 20 vol % H₂O and 0.28 mV·h⁻¹ in 85 vol % H₂O. Liu et al. reported a degradation rate of 0.005 mV·h⁻¹ in 3 vol % H₂O and 0.04 mV·h⁻¹ in 30 vol % H₂O using BZCYYb1711 based PCECs. Current strategies for enhancing the stability are usually at the expense of proton conductivities or faradic efficiencies, not leading to a well-rounded PCEC solution. Hence, new strategies are needed to retain high performance and overcome instability essentially.

Despite progress in the development of highly conductive doped barium cerate electrolytes and active triple conducting oxide (TCO) air electrodes, formidable challenges remain in realizing the long-term performance stability of PCECs, especially under industrially relevant operational conditions in terms of high-concentration steam (P_{H2O}≥40%), large current densities (j≥1 A cm⁻²), and durability for more than thousands of hours. Most reports on PCECs demonstrated their electrolysis stability at low P_{H2O} (3-12%) for hundreds of hours with a degradation rate (>10 μV h⁻¹). Only a few papers reported PCECs that operated under high P_{H2O} (≥40%) but showed significantly higher degradation rates (280-787 μV h⁻¹). To date, the longest electrolysis stability duration of PCEC is 1833 h under P_{H2O} of merely 12% showing a degradation rate of 40 μV h⁻¹. This falls short of the requirements of PCEC for viable utility-scale applications, since high-concentration steam is required for electrolysis to avoid the reactant dilution and Faradaic efficiency loss, and ensure industrially meaningful H₂ production. Meanwhile, operation in the FC mode for power output can create a locally high steam environment in the oxygen electrode. Therefore, the long-term operational stability of the oxygen electrode and electrolyte against high-concentration steam is a prerequisite for promoting the viable deployment of PCECs. To date, reported strategies have focused on composition engineering of electrolytes and oxygen electrodes (e.g., doping, design of new phases, and composite mixing), surface modification (coating and in situ exsolution) and porosity tuning for oxygen electrodes to effectively enhance the electrocatalytic activities and proton conductivities. However, the operational stability of those PCECs under industrially relevant conditions (P_{H2O}≥40% and j≥1 A cm⁻²) has remained limited for merely 100 h.

Despite advances in PCEC research, there is still a lack of suitable materials for producing R-PCECs that are robust, sustainable, and inexpensive. Ideal materials and devices would be scalable for industrial production and use, would have long-term operational stability, and would meet established standards. In addition to catalytic activity, the electrode and electrolyte in an ideal R-PCEC would have comparable thermal expansion coefficients to ensure high thermo-mechanical compatibility, would have high chemical stability, and would have sufficient thermal cycle durability to ensure long-term operation, without sacrificing proton conductivities or faradic efficiencies. These needs and other needs are satisfied by the present disclosure.

### SUMMARY

In accordance with the purpose(s) of the present disclosure, as embodied and broadly described herein, the disclosure, in one aspect, relates to conformal coating scaffold electrodes having a sintered porous perovskite scaffold and a continuous, uniform catalyst coating covering the scaffold. In one aspect the perovskite can have the formula BaZrₓCe_{y}Y_{z}Yb_{(1-x-y-z)}O_{3-δ}, wherein 0.1≤x≤0.8, wherein 0≤y≤0.8, and wherein 0≤z≤0.3, while the catalyst can have the formula Pr₂₋ₓBaₓNiO_{4+δ}, wherein 0≤x≤0.4 (PBNO). The disclosed electrodes exhibit improved long-term operational stability compared to current technology and are sustainable, scalable, and inexpensive to produce. Also disclosed are methods for making the coating, electrochemical cells comprising the electrodes, and devices incorporating the electrochemical cells.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D show a schematic illustration of (FIG. 1A) as-prepared electrode scaffold; infiltrated scaffold with conformal coating; infiltrated scaffold with discrete coating. (FIG. 1B) Reaction mechanism of conformal coating scaffold electrode. (FIG. 1C) Computational fluid dynamics modeling on the performance of PCEC with two types of air electrodes. (FIG. 1D) Density function theory calculation on the effect of Ba replacement on hydration energies.

FIGS. 2A-2D show typical top morphology of the (FIG. 2A) pristine BZCYYb1711 scaffold and PBNO films derived from the infiltrating solutions with different surfactants, (FIG. 2B) PVP, (FIG. 2C) PVA, (FIG. 2D) TX-100.

FIGS. 3A-3E show SEM and TEM characterization of (FIG. 3A) clean particle of pristine BZCYYb1711 scaffold; cross-section images of PBNO films derived from the infiltrating solutions with different surfactants. (FIG. 3B) PVP, (FIG. 3C) PVA, (FIG. 3D) TX-100. (FIG. 3E) TEM view of the outer portion of BZCYYb grain and surface coated PBNO layer.

FIGS. 4A-4B show the polarization resistance of conformal coating scaffold electrode (FIG. 4A) with different wt. % graphite as pore former in a 40 vol % H₂O-air environment and (FIG. 4B) During thermal cycles and 200 hours immersion in a 40 vol % H₂O-air environment. The thermal cycling experiment was conducted from 100° C. to 600° C. with a ramp rate of 20° C./min and naturally cooled down within a furnace.

FIGS. 5A-5I show electrochemical performances of the PCECs with CCS electrodes. FIG. 5A, Polarization curves of PBNO-BZCYYb1711 CCS electrolysis cell at 450-650° C. with 100% H₂ in the fuel electrode and 5% H₂O-air in the air electrode. FIG. 5B, Comparison of the electrolysis current density at 1.3 V for the developed and other reported PCECs with air electrodes of PNC (PrNi_{0.5}Co_{0.5}O_{3-δ}), BCFZY (BaCo_{0.4}Fe_{0.4}Zr_{0.1}Y_{0.1}O_{3-δ}), PBSCF (PrBa_{0.5}Sr_{0.5}Co₂₋ₓFeₓO_{5+δ}), BGLC (Ba₁₋ₓGd_{0.8}La_{0.2+x}Co₂O_{6-δ}), LCCN (La_{0.7}Ca_{0.3}Co_{0.8}Ni_{0.2}O₃), SCFN (SrₓCe_{y}FeₘNiₙO_{3-δ}), PBCC (PrBa_{0.2}Ca_{0.2}Co₂O_{5+δ}), BGPC (Ba_{0.8}Gd_{0.8}Pr_{0.4}Co₂O_{5+δ}), BCMN (Ba₂Co_{1.5}Mo_{0.25}Nb_{0.25}O_{6-δ}), PBCFN (PrBaCo_{1.6}Fe_{0.2}Nb_{0.2}O_{5+δ}), and NBSCF (NdBa_{0.5}Sr_{0.5}Co_{1.5}Fe_{0.5}O_{5+δ}) under similar conditions. FIG. 5C, Polarization, and power density curves of PBNO-BZCYYb1711 CCS fuel cell at 450-650° C. with 100% H₂ in the fuel electrode and O₂ in the air electrode. FIG. 5D, Long-term stability of PBNO-BZCYYb1711 CCS fuel cells with 100% H₂ in the fuel electrode and humidified air (10% and 20% H₂O) in the air electrode at 0.4 A cm ⁻² and 600° C. FIG. 5E, Long-term stability of PBNO-BZCYYb1711 CCS electrolysis cell with 40% H₂O-air in the air electrode at −0.5 A cm⁻² and 500° C. FIG. 5F, Long-term stability of the PBNO CCS based electrolysis cells with BZCYYb1711, BZCYYb4411, and BCY20 electrolytes and scaffolds and 40% H₂O-air in the air electrodes at 600° C. under high current densities. FIG. 5G, Comparison of the degradation rates of the CCS and DCS-based PCECs under different steam concentrations with those of reported PCECs with the planar-contact electrode design. FIG. 5H, Comparison of the electrolysis stability and degradation rates for the PBNO-BZCYYb1711 PCECs with PC, composite, DCS, and CCS air electrodes. FIG. 5I, Thermal cycle durability of the PBNO-BZCYYb1711 CCS electrolysis cell under harsh conditions of drastic temperature fluctuation between 400 and 600° C. with a ramping/cooling rate of 10° C. min⁻¹ at 1.3 V.

FIGS. 6A-6H show reversible operation and analysis in hydrogen and power generation. The reversible operation of the electrochemical cell between electrolysis mode (hydrogen production) and fuel cell mode (electricity generation) at different current densities to examine the capability of converting hydrogen generated by electrolysis into electricity. (FIG. 6A) The schematic illustration of the self-sustain reversible operation set-up and its operation in both fuel cell and electrolysis modes. Voltage observation under switchable electrolysis and fuel cell current densities without external hydrogen supply at (FIG. 6B) 600° C. (FIG. 6C) 550° C. (FIG. 6D) 500° C. (FIG. 6E) with external hydrogen feeding at 600° C. (FIG. 6F) Daily hydrogen production and electricity generation assuming a 12 h-12 h reversible scheduling. (FIG. 6G), Long-duration deep cycling of UR-PCEC that alternates between EC and FC modes every 12 h simulating the real-world day-night cycle operation without external H₂ supply at 600° C. (FIG. 6H), Polarization curves of PCECs with 40% steam from deionized water and seawater in the air electrode at 600° C. Inset is the stability of seawater steam electrolysis at −1 A cm⁻².

FIGS. 7A-7H show top morphology of the PBNO conformal coating scaffold electrode fabricated on PCEC (FIG. 7A) before operations, (FIG. 7C) after 300 hours operation, (FIG. 7E) after 1000 hours of operation, (FIG. 7G) after 5000 hours of operation. Cross-section images of the PBNO conformal coating scaffold electrode fabricated on PCEC (FIG. 7B) before operations, (FIG. 7D) after 300 hours of operation, (FIG. 7F) after 1000 hours of operation, (FIG. 7H) after 5000 hours of operation. Particles on BZCYYb1711 scaffold cross-section in (FIG. 7F) are sputtered gold particles from SEM sample preparation.

FIG. 8 shows a sketch of the working mechanism of protonic ceramic (left) fuel cells and (right) electrolysis cells. H₂O associative desorption in a fuel cell takes place at the air electrode (cathode), while H₂O dissociative adsorption in an electrolysis cell takes place at the air electrode (positive electrode). With the help of conformal coating-scaffold structure, H₂O adsorption and desorption can be confined on the coating surface rather than on the electrode surface and electrode/electrolyte interface. The scaffold as a substrate of the coating layer will facilitate the reaction network expansion by Galvani potential driven proton migrations.

FIGS. 9A-9B show a comparison of the Rₚ stability of symmetrical cells with PC, DCS, and CCS electrodes when exposed to 40% H₂O-air at 600° C. for 192 h. FIG. 9B: SEM images of symmetric cells with PC (top), DCS (middle), and CCS (bottom) electrodes after their Rₚ stability tests.

FIGS. 10A-10C show an illustration of the PCEC fabrication methods and electrolysis and fuel cell stability performance comparison. FIG. 10A, Schematic illustration of the proposed PCEC fabrication method with the conformally coated scaffold (CCS) based air electrode design. The dense electrolyte and scaffold based on doped barium cerates (BZCYYb) are BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or BaCe_{0.8}Y_{0.2}O_{3-δ} (BCY20). The air electrode is Pr_{1.8}Ba_{0.2}NiO_{4.1} (PBNO). The fuel electrode is NiO and electrolyte composite. FIGS. 10B-10C, Comparison of the electrolysis (FIG. 10B) and fuel cell (FIG. 10C) stability of the CCS-based PCECs in terms of degradation rates and operational duration with those of reported PCECs with the planar contact air electrode design.

FIGS. 11A-11K show material characterizations. (FIGS. 11A-11B), 3D digital microscopic surface topography of a flat dense electrolyte (FIG. 11A) and porous scaffold on the dense electrolyte (FIG. 11B). FIGS. 11C-11E, XRM images of 3D structure (FIG. 11C), cross-section morphology (FIG. 11D), and colored phase/contrast map (FIG. 11E) for the uncoated scaffold cell. The three layers with distinct color contrast are highly porous BZCYYb1711 scaffold (top), dense BZCYYb1711 electrolyte (middle), and NiO and electrolyte composite (bottom). FIGS. 11F-11G, SEM images of the cross-section morphologies of bare BZCYYb1711 scaffold/electrolyte interface from co-sintering (FIG. 11F) and CCS/electrolyte interface after coated by PBNO (FIG. 11G). FIGS. 11H-11I, High-magnification SEM images of scaffold grain particles coated by PBNO (FIG. 11H) and dense electrolyte surface covered by PBNO (FIG. 11I). FIG. 11J, HAADF-STEM and STEM secondary electron images of a sample slice near the PBNO-CCS electrode/electrolyte interface with the corresponding elemental maps. FIG. 11K, HRTEM image of PBNO-CCS of BZCYYb1711 with their FFT patterns.

FIGS. 12A-12H show multiscale and multiphysics modeling computations for the CCS-based air electrode under the EC mode. FIGS. 12A-12B, Contour plots of ionic (proton) current density distributions for the PC (FIG. 12A) and CCS (FIG. 12B) electrodes at 1.3 V and 600° C. via CFD simulations. FIG. 12C, Comparison of simulated electrolysis polarization curves of the PC and CCS electrodes with different grain particle diameters. The experimental polarization curve of CCS electrode with a grain diameter of ˜0.3 μm is shown for validation of the simulated one. Inset is the comparison of the simulated electrolysis current densities of PC and CCS electrodes with different grain particle diameters at 1.3 V and 600° C. FIG. 12D, DFT calculations for revealing the effect of Ba dopant on the hydration energy of PBNO. FIG. 12E, DOS profiles of PBNO and PNO. FIG. 12F, Simulated electrolysis polarization curve of the CCS electrode as a function of relative hydration capability. Inset shows the effect of relative hydration capability on the simulated electrolysis current density at 1.3 V and 600° C. FIG. 12G, AIMD simulation of dissociated H₂O in bulk PBNO displaying the trajectory of a proton. FIG. 12H, Simulated electrolysis polarization curve of the CCS electrode as a function of relative proton diffusivity. Inset shows the effect of relative proton diffusivity on the simulated electrolysis current density at 1.3 V and 600° C.

FIGS. 13A-13B show the effects of H₂O concentration in the air electrode feeding gas, operation temperature and voltage on the electrolysis performance. FIG. 13A, Polarization curves of PBNO-BZCYYb1711 CCS cell under the electrolysis cell mode at 600° C. with 100% H₂ in the fuel electrode and humidified air with varying H₂O percentages in the air electrode, demonstrating that the increased H₂O concentration can enhance the electrolysis performance and lower the open circuit voltage (OCV) in agreement with the previously reported result. FIG. 13B, Faradaic efficiency (FE) of PBNO-BZCYYb7111 CCS-based electrolysis cells as a function of voltage under different conditions of temperature and H₂O concentration showing the effects of operation temperature, voltage, and H₂O concentration on the FE. The measurements were carried out at different temperatures (500-650° C.) with 10% and 40% H₂O-air in the air electrodes. The increased H₂O concentration under the fixed operation temperature and voltage can promote the FE, highlighting the importance of PCEC operation in high-concentration steam under the electrolysis cell mode.

FIGS. 14A-14C show evolution of the area specific resistance (ASR) of PBNO CCS based electrolysis cells with different electrolytes and scaffolds during the long-term electrolysis under the industrially relevant conditions. FIG. 14A, PBNO-BZCYYb1711 CCS based electrolysis cell during 5000-hour operation at −1.5 A cm⁻². FIG. 14B, PBNO-BZCYYb4411 CCS based electrolysis cell during 2600-hour operation at −1.0 A cm⁻². FIG. 14C, PBNO-BCY20 CCS based electrolysis cell during 1000-hour operation at −1.0 A cm⁻². The long-term electrolysis stability was tested with 40% H₂O-air in the air electrodes at 600° C.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein is a conformal coating scaffold electrode consisting of a highly conductive and active Pr₂₋ₓBaₓNiO_{4+δ} shell on a porous core BZCYYb1711. The disclosed conformal coating scaffold electrode can be inexpensively produced and significantly enhances the electrochemical performance and boosts the air electrode stability of a BZCYYb1711 electrolyte-based R-PCEC. In one aspect, the PBNO-BZCYYb1711 conformal coating scaffold electrode design has been shown to achieve high electrolyzing performance and excellently stability compared to traditional electrode designs. In another aspect, the outstanding electrochemical activity and durability of the air electrode were examined in high steam concentration environments for 5000 hours and in self-sustain reversible operating conditions. Without wishing to be bound by theory, post-examination of the conformal coating electrodes confirmed that the robust PBNO functions as a protective layer of BZCYYb1711 in the high steam concentration at the air electrode side.

The underlying factors leading to PCEC performance degradation under industrially relevant conditions have not been comprehensively addressed.8, 27 Here, it is proposed that the root causes for the degradation are the intrinsic chemical instability of the commonly used proton-conducting electrolytes typically based on doped barium cerates and most oxygen electrode materials against high-concentration steam, and poor oxygen electrode-electrolyte interfacial contact. These issues need to be addressed holistically to realize the high operational stability of PCECs under industrially relevant conditions. Although most efforts focus on engineering the electrolyte composition, the development of an electrolyte with both high proton conductivity and thermodynamic/chemical stability against steam presents a significant challenge.

The conventional cell fabrication process (e.g. screen printing, spin-coating, dip-coating, tape-casting) also produces a planar-contact (PC) electrode/electrolyte configuration, where the electrode particles are stacked and sintered on a dense electrolyte. The porosity of electrode particles makes the doped barium cerate electrolytes (e.g., BaZr_{0.1}Ce_{0.7}Y_{0.1}Yb_{0.1}O_{3-δ}) inevitably exposed to steam, resulting in phase decomposition. Therefore, it is necessary to fully isolate the electrolyte from steam for achieving the desired operational stability. Likewise, an impossible trinity may exist for TCO electrodes in terms of high proton conductivity, stability, and activity. Many oxygen electrode materials (especially cobalt-containing ones) are not stable in steam, leading to decomposition, surface restructuring, and uncontrolled exsolution. Although some exsolved particles may be electrocatalytically active, their inhomogeneous coverage, continuous and uncontrolled exsolution, and structural decomposition of perovskite parents can cause performance degradation.26 Additionally, the oxygen electrode-electrolyte interfacial contact affinity is not sufficiently strong in this PC configuration, resulting from the requirement of low electrode sintering temperatures to avoid electrode particle agglomeration and possible unmatched thermal expansion coefficient (TEC). A weak interfacial contact and electrolyte/electrode phase decomposition under steam can lead to high interfacial resistance, electrode delamination, and severe performance degradation during cycling and thermal shock. In such a PC electrode/electrolyte configuration, the oxygen electrodes with limited proton conductivities and electrode-electrolyte interfacial contact areas lead to a limited proton conducting network with sluggish proton diffusion kinetics and restricted electrochemically active surface area (ECSA). Therefore, a new mitigation strategy is required to tackle the complex challenges of chemical instability of TCO electrodes and electrolytes in steam, limited interfacial contact areas, weak interfacial binding, and the creation of a stable and continuous proton conducting network for realizing long-term operational durability, and stability for deep cycling and thermal shock under industrially relevant conditions.

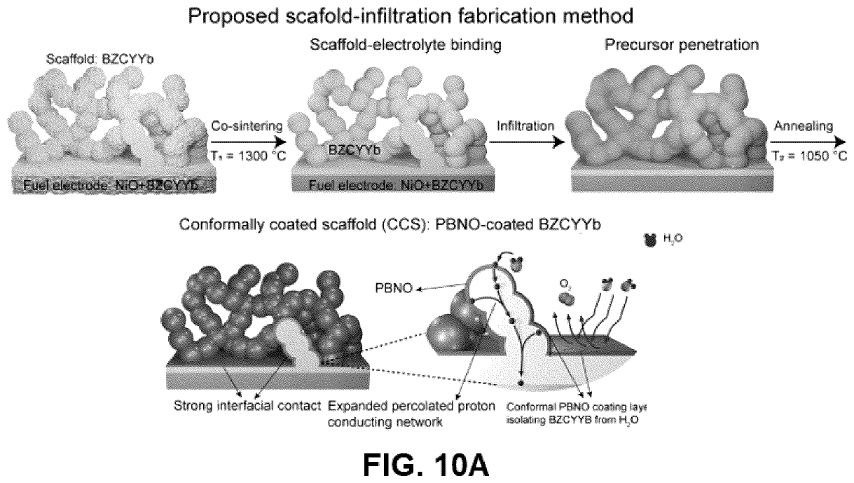

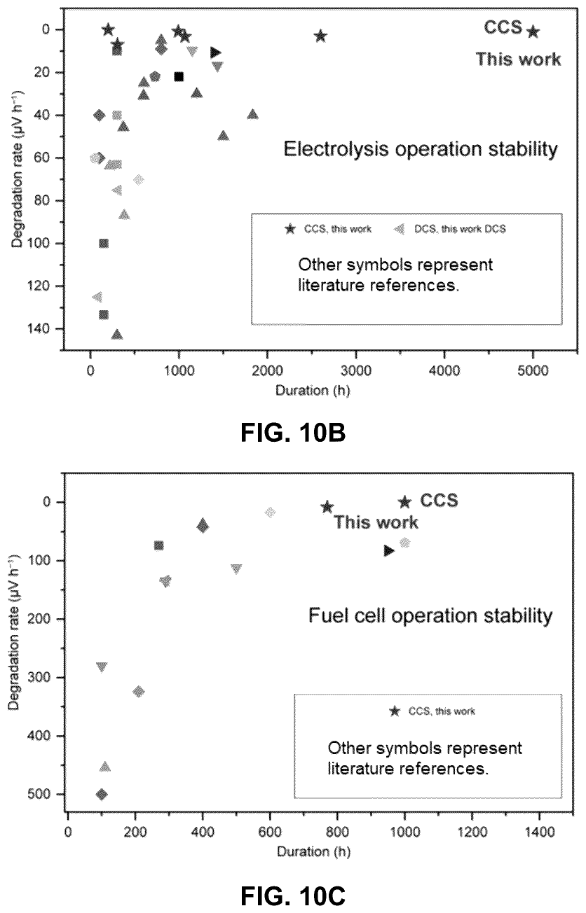

Disclosed herein is a novel holistic approach to addressing multiple issues of limited operational stability in high-concentration steam, electrode/electrolyte interfacial contact, and proton transport for PCECs. This versatile structure design strategy involves constructing a porous electrolyte scaffold and conformally coating it with a H₂O-resistant TCO electrocatalyst (oxygen electrode). This approach is first demonstrated using Pr_{1.8}Ba_{0.2}NiO _{4.1} that has high chemical stability against H₂O, electrocatalytic activity, and triple conductivity to conformally coat a porous BaZr_{0.1}Ce_{0.7}Y_{0.1}Yb_{0.1}O_{3-δ} (BZCYYb1711) electrolyte scaffold (FIG. 10A), which forms a continuous and uniform protective layer of PBNO over BZCYYb1711 to isolate the vulnerable electrolyte from steam. This conformally coated scaffold (CCS) cell architecture design is a general design principle that can be universally applied to a family of doped barium cerate-based proton conducting electrolytes, including BZCYYb1711, BaZr_{0.4}Ce_{0.4}Y_{0.1}Yb_{0.1}O_{3-δ} (BZCYYb4411), and BaCe_{0.8}Y_{0.2}O_{3-δ} (BCY20). Although a similar method has been used in O-SOCs, only a few reports have employed it in PCECs with a discretely coated scaffold (DCS) design which developed discrete coating of secondary oxygen-ion conductive metal oxide nanoparticles with little proton conductivity on the electrode scaffolds aiming to extend the triple phase boundary (TPB) length towards higher activities, but failed to demonstrate the stability in high-concentration steam because of the insufficient surface coverage leading to inevitable exposure of the electrolyte scaffold to H₂O. In contrast to that DCS design, the present CCS cell design with triple conducting PBNO as a continuous protective coating layer features high chemical stability against H₂O, strong PBNO/electrolyte interfacial contact affinity, percolated proton conducting network, and thermomechanical stability.

As a result, the disclosed CCS-based PCEC shows unprecedentedly high electrolysis operational stability at −1.5 A cm⁻² and 600° C. in 40% H₂O for 5000 h (from 1.3345 to 1.3395 V), leading to an extremely low degradation rate of 1 μV h⁻¹. This is the highest long-term electrolysis stability of PCECs under industrially relevant harsh conditions (FIG. 10B). A technoeconomic analysis demonstrates that the disclosed CCS-based PCEC has a lower levelized cost of H₂ (LCOH) than state-of-the-art PCECs and O-SOCs primarily due to its unprecedented electrolysis operation stability. Moreover, the CCS-based PCEC exhibits exceptional stability for 1000 h without degradation under the FC mode conditions (0.4 A cm⁻² and 600° C. and humidified air with 10% H₂O), outperforming most reported PCECs (FIG. 10C). Due to its remarkable performance under both EC and FC modes, the CCS cell is integrated with H₂ circulation and storage auxiliary components to demonstrate a unitized regenerative PCEC (UR-PCEC) prototype system that can operate under both frequent EC/FC alternation (2-hour interval) and harsh long-duration deep cycling (12-hour interval) conditions without external H₂ supply, showing high stability and great potential for smoothing grid variations and managing long-duration energy storage and electricity supply. Multiscale multiphysics modeling and computations shed light on the mechanistic insights into the enhanced electrolysis performance for the unique CCS design with PBNO. Overall, this work provides a holistic mitigation strategy for the rational design of stable UR-PCECs as an efficient, resilient, and durable electrochemical energy conversion and storage system. This design strategy has the potential for applications in solid-state batteries, heterogeneous catalysis, and other ceramic-based energy devices.

In one aspect, disclosed herein is a conformal coating scaffold electrode having a sintered perovskite mesh scaffold and a conformal catalyst coating. In one aspect, the sintered perovskite mesh scaffold has a formula BaZrₓCe_{y}Y_{z}Yb_{(1-x-y-z)}O_{3-δ}, wherein 0.1≤x≤0.8, wherein 0≤y≤0.8, and wherein 0≤z≤0.3. In a further aspect, the sintered perovskite mesh scaffold can be or include BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof, while the conformal catalyst coating can be or include Pr₂₋ₓBaₓNiO_{4+δ}, wherein 0≤x≤0.4 (PBNO), or can have the formula Pr_{1.8}Ba_{0.2}NiO_{4.1}. In any of these aspects, the catalyst coating forms a continuous, uniform film over the scaffold. In some aspects, the film can be from about 20 nm to about 200 nm thick, or from about 50 nm to about 150 nm thick, or can be from about 90 nm to about 140 nm thick. In another aspect, the conformal coating scaffold electrode can include from about 10 vol % to about 80 vol %, or from about 25 vol % to about 75 vol %, or about 50 vol % catalyst coating.

Also disclosed herein are methods for making the conformal coating scaffold electrode. In one aspect, the method includes at least the steps of (a) infiltrating a porous perovskite mesh scaffold with a solution containing a catalyst, a surfactant, a chelating agent, and a solvent to create a precursor scaffold; and (b) sintering the precursor scaffold to produce the conformal coating scaffold electrode. In an aspect, a total concentration of cations in the catalyst can be from about 0.2 to about 1.6 M, or from about 0.3 to about 1 M, or can be about 0.6 M. In another aspect, the surfactant can be present in the solution in an amount from about 0.1 to about 3 wt %, or from about 0.2 to about 2 wt %, or of about 1 wt % relative to the amount of catalyst. In still another aspect, the surfactant can be selected from polyvinyl alcohol (PVA), polyvinyl pyrrolidone (PVP), Triton X-100, polydopamine, polyethylene glycol, or any combination thereof. In an aspect, the chelating agent can be ethylenediaminetetraacetic acid (EDTA), ethylene glycol, urea, glycine, or any combination thereof, and can be present in the solution in a concentration of from about 0.5 to about 1.2 M, or of about 0.6 to about 1 M, or can be about 0.9 M. In one aspect, the solvent can be water and can have a pH of from about 3 to 9, or from about 3 to 6, or can be about 4. In an alternative aspect, the solvent can be a mixture of water and ethanol, provided that the amount of ethanol is equal to or less than the amount of water on a volume percent basis.

In any of these aspects, the solution further includes a pore former such as, for example, graphite, polymethyl methacrylate (PMMA), starch, tapioca flour, wheat flour, or any combination thereof, which can be present in the solution at a concentration of about 20 wt % to about 60 wt %.

In one aspect, in the method, step (a) can be repeated at least 40 times and step (b) can be carried out from about 800 to about 1050° C., or from about 850 to about 1000° C., or at about 1000° C. for from about 1 to about 4 hours, or for about 2 hours. Also disclosed herein are conformal coating scaffold electrodes produced by the disclosed methods.

In a further aspect, disclosed herein is a symmetrical cell including a disclosed conformal coating scaffold electrode. In an aspect, the symmetrical cell can have a polarization resistance of less than about 0.2 Ω·cm², or of less than about 0.15 Ω·cm², or of about 0.148 Ω·cm². In any of these aspects, a final polarization resistance after 200 hours of operation is no more than about 10% greater than an initial polarization resistance. Further in this aspect, the initial polarization resistance and the final polarization resistance can be measured in an environment having from about 30 vol % to about 60 vol % H₂O in air, or in a 40 vol % H₂O in air environment. In one aspect, operation includes repeated thermal cycles from a first temperature of about 100° C. to a second temperature of from about 600 to about 750° C. and back to the first temperature. In one aspect, the second temperature is about 600° C. In an alternative aspect, the second temperature is about 750° C.

Also disclosed herein are single electrochemical cells including the disclosed conformal coating scaffold electrodes. In one aspect, the single electrochemical cells further include a fuel electrode support. Further in this aspect, the fuel electrode support can include NiO, one or more perovskite precursors, and a pore former such as, for example, starch or another pore former as disclosed herein. In one aspect, the one or more perovskite precursors can include Ba, Ce, Zr, Y, and Yb (BZCYYb). In a further aspect, the NiO, the BZCYYb, and the pore former can be present in a ratio of about 5:5:2 by weight.

Also disclosed herein are devices including the disclosed single electrochemical cells and symmetrical cells. In a further aspect, the devices can be or include a fuel cell or an electrolysis cell.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a pore former,” “a chelating agent,” or “an electrolyte,” include, but are not limited to, mixtures or combinations of two or more such pore formers, chelating agents, or electrolytes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x,’‘about y,’ and ‘about z’ as well as the ranges of ‘greater than x,’ greater than y,’ and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a surfactant refers to an amount that is sufficient to achieve the desired improvement in the property modulated by the formulation component, e.g. achieving the desired thickness of conformal coating on the porous perovskite scaffold. The specific level in terms of wt % in a composition required as an effective amount will depend upon a variety of factors including the amount and type of surfactant, solution conditions including other materials present, pH, and solvent, and desired thickness and/or other properties of the coating.

As used herein, the terms “optional” or “optionally” means that the subsequently described event or circumstance can or cannot occur, and that the description includes instances where said event or circumstance occurs and instances where it does not.

As used herein, “PBNO” refers to a compound having the formula Pr₂₋ₓBaₓNiO_{4+δ}, wherein 0≤x≤0.4, such as, for example, Pr_{1.8}Ba_{0.2}Ni_{1.0}O_{4-δ}, while “BZCYYb1711” refers to BaZr_{0.1}Ce_{0.7}Y_{0.1}Yb_{0.1}O_{3-δ} and “BZCYYb4411” refers to BaZr_{0.4}Ce_{0.4}Y_{0.1}Yb_{0.1}O_{3-δ}.

When used in a subscript of a chemical formula herein, δ indicates that during the course of normal use for a device containing a given chemical species such as a catalyst, perovskite, or the like, the amount of the atom with a subscript δ in the chemical species may vary and can thus be present in a nonstoichiometric amount. For example, Pr₂₋ₓBaₓNiO_{4+δ} indicates that greater than stoichiometric amounts of oxygen may sometimes be present during a given stage in a process, while BaZrₓCe_{y}Y_{z}Yb_{(1-x-y-z)}O_{3-δ} indicates that less than stoichiometric amounts of oxygen may sometimes be present.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.

Aspect 1. A conformal coating scaffold electrode comprising a sintered perovskite mesh scaffold and a conformal catalyst coating.

Aspect 2. The conformal coating scaffold electrode of aspect 1, wherein the sintered perovskite mesh scaffold comprises BaZrₓCe_{y}Y_{z}Yb_{(1-x-y-z)}O_{3-δ}, wherein 0.1≤x≤0.8, wherein 0≤y≤0.8, and wherein 0≤z≤0.3.

Aspect 3. The conformal coating scaffold electrode of aspect 1 or 2, wherein the sintered perovskite mesh scaffold comprises BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

Aspect 4. The conformal coating scaffold electrode of any one of aspects 1-3, wherein the conformal catalyst coating comprises Pr₂₋ₓBaₓNiO_{4+δ}, wherein 0≤x≤0.4.

Aspect 5. The conformal coating scaffold electrode of any one of aspects 1-4, wherein the conformal catalyst coating comprises Pr_{1.8}Ba_{0.2}NiO_{4.1} (PBNO).

Aspect 6. The conformal coating scaffold electrode of any one of aspects 1-5 wherein the catalyst coating forms a continuous, uniform film over the scaffold.

Aspect 7. The conformal coating scaffold electrode of aspect 6, wherein the film is from about 20 nm to about 200 nm.

Aspect 8. The conformal coating scaffold electrode of any one of aspects 1-7, wherein the conformal coating scaffold electrode comprises about from about 10 vol % to about 80 vol % catalyst coating.

Aspect 9. A method for making the conformal coating scaffold electrode of any one of aspects 1-8, the method comprising:
(a) infiltrating a porous perovskite mesh scaffold with a solution comprising a catalyst, a surfactant, a chelating agent, and a solvent to create a precursor scaffold; and
(b) sintering the precursor scaffold to produce the conformal coating scaffold electrode.

Aspect 10. The method of aspect 9, wherein the porous perovskite mesh scaffold comprises BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

Aspect 11. The method of aspect 9 or 10, wherein the catalyst comprises Pr_{1.8}Ba_{0.2}NiO_{4.1} (PBNO).

Aspect 12. The method of any one of aspects 9-11, wherein a total concentration of cations in the catalyst is from about 0.3 to about 1.6 M.

Aspect 13. The method of any one of aspects 9-12, wherein the surfactant is present in the solution in an amount of from about 0.1 to about 3 wt % relative to the amount of catalyst.

Aspect 14. The method of any one of aspects 9-13, wherein the surfactant comprises polyvinyl alcohol (PVA), polyvinyl pyrrolidone (PVP), Triton X-100, polydopamine, polyethylene glycol, or any combination thereof.

Aspect 15. The method of aspect 14, wherein the surfactant is PVP.

Aspect 16. The method of any one of aspects 9-15, wherein the chelating agent comprises ethylenediaminetetraacetic acid (EDTA), ethylene glycol, urea, glycine, or a combination thereof.

Aspect 17. The method of any one of aspects 9-16, wherein the chelating agent is present in the solution in a concentration of about 0.5 to about 1.2 M.

Aspect 18. The method of any one of aspects 9-17, wherein the solvent is water or a mixture of ethanol and water, wherein an amount of ethanol is less than or equal to an amount of water.

Aspect 19. The method of aspect 18, wherein the solvent has a pH of from about 3 to about 9.

Aspect 20. The method of any one of aspects 9-19, wherein the solution further comprises a pore former.

Aspect 21. The method of aspect 20, wherein the pore former comprises graphite, polymethyl methacrylate (PMMA), starch, tapioca flour, wheat flour, or any combination thereof.

Aspect 22. The method of aspect 20 or 21, wherein the pore former is present in a concentration of about 20 to about 60 wt % in the solution.

Aspect 23. The method of any one of aspects 20-22, wherein the pore former is graphite and the graphite is present at about 40 wt % in the solution.

Aspect 24. The method of any one of aspects 9-23, wherein step (a) is repeated at least 40 times.

Aspect 25. The method of any one of aspects 9-24, wherein step (b) is carried out at from about 800 to about 1050° C.

Aspect 26. The method of any one of aspects 9-25, wherein sintering is carried out for from about 1 to about 4 h.

Aspect 27. A conformal coating scaffold electrode produced by the method of any one of aspects 9-26.

Aspect 28. The conformal coating scaffold electrode of aspect 27, wherein the catalyst forms a continuous, uniform film over the scaffold.

Aspect 29. The conformal coating scaffold electrode of aspect 27 or 28, wherein the film is from about 20 nm to about 200 nm thick.

Aspect 30. The conformal coating scaffold electrode of any one of aspects 27-29, wherein the conformal coating scaffold electrode comprises from about 10 to about 80 vol % catalyst.

Aspect 31. A symmetrical cell comprising the conformal coating scaffold electrode of any one of aspects 1-8 or 27-30.

Aspect 32. The symmetrical cell of aspect 31, wherein the symmetrical cell has a polarization resistance less than about 0.2 Ω·cm².

Aspect 33. The symmetrical cell of aspect 31 or 32, wherein a final polarization resistance after 200 hours of operation is no more than about 10% greater than an initial polarization resistance.

Aspect 34. The symmetrical cell of any one of aspects 31-33, wherein the initial polarization resistance and the final polarization resistance are measured in an environment containing from about 30 vol % to about 60 vol % H₂O in air.

Aspect 35. The symmetrical cell of any one of aspects 31-34, wherein operation comprises repeated thermal cycles from a first temperature to a second temperature and back to the first temperature.

Aspect 36. The symmetrical cell of aspect 35, wherein the first temperature is about 100° C. and the second temperature is from about 600 to about 750° C.

Aspect 37. A single electrochemical cell comprising the conformal coating scaffold electrode of any one of aspects 1-8 or 27-30.

Aspect 38. The single electrochemical cell of aspect 37, further comprising a fuel electrode support.

Aspect 39. The single electrochemical cell of aspect 38, wherein the fuel electrode support comprises NiO, one or more perovskite precursors, and a pore former.

Aspect 40. The single electrochemical cell of aspect 39, wherein the one or more perovskite precursors comprise Ba, Ce, Zr, Y, and Yb (BZCYYb).

Aspect 41. The single electrochemical cell of aspect 40, wherein the NiO, the BZCYYb, and the pore former are present in a ratio of about 5:5:2 by weight.

Aspect 42. A device comprising the symmetrical cell of any one of aspects 29-34 or the single electrochemical cell of any one of aspects 37-41.

Aspect 43. The device of aspect 42, wherein the device comprises a fuel cell or an electrolysis cell.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Conceptual Design

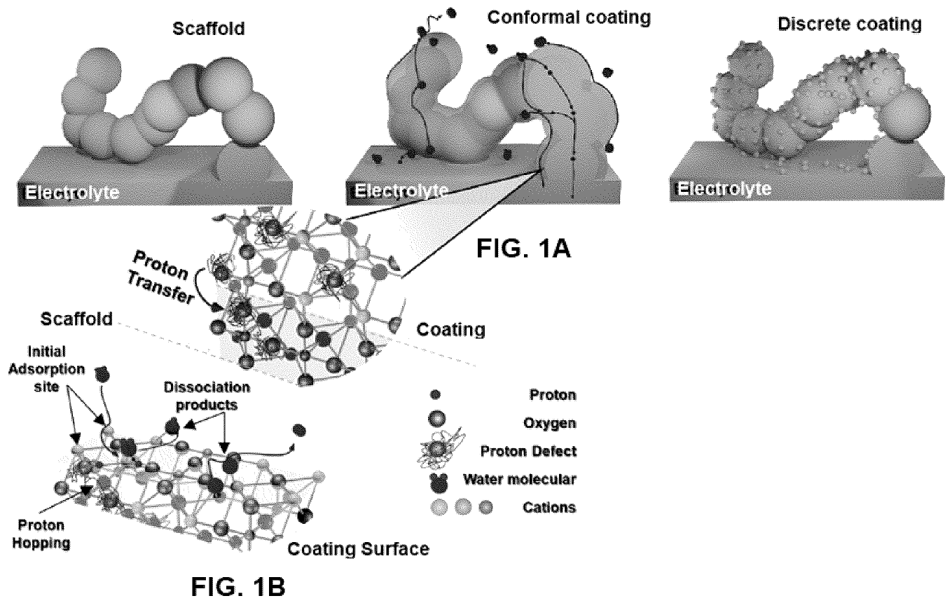

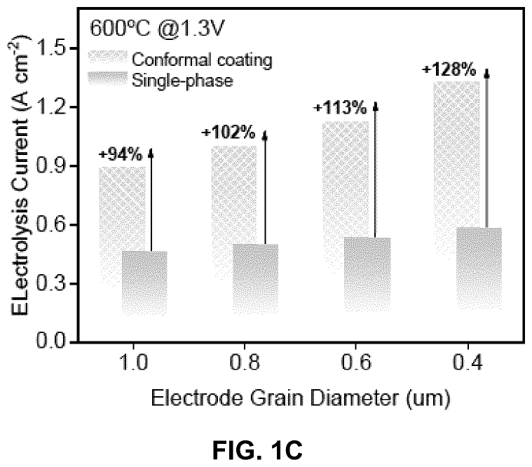

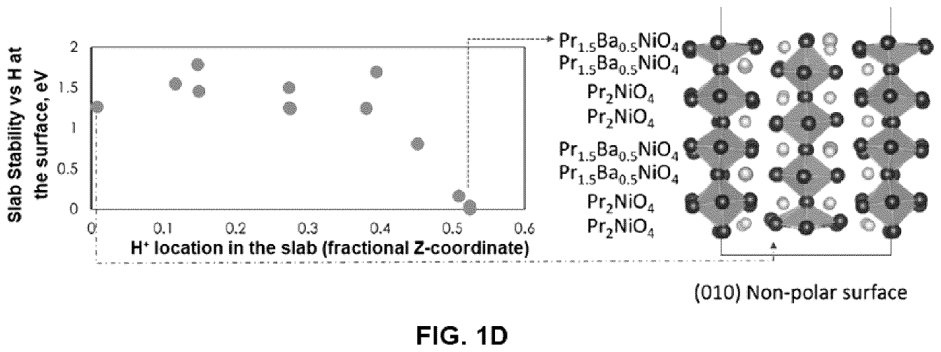

The operational degradation of current PCECs mainly originates from the electrolyte deterioration at electrolyte/H₂O/electrode phase boundaries. As previous studies demonstrated, such degradation can be mitigated at the expense of catalytic activity by introducing an H₂O stable layer La₂Ce₂O₇ between the electrolyte and air electrode or using Zr-rich electrolyte. Although these methods do not provide a well-round solution, they follow the same principle of preventing direct contact/reaction between H₂O and sensitive materials. Inspired by these studies, it is promising to improve PCEC stability without sacrificing performance by fabricating a conductive, catalytic active, and steam stable catalyst coating covering the exposed electrolyte at the air electrode side. Together with a performance-oriented electrode microstructure design, outstanding electrochemical activity and durability can be achieved simultaneously. Therefore, as shown in FIG. 1A, a continuous, uniform, and dense triple conducting film that maintains a conformal microstructure as BZCYYb1711 scaffold film will be desired to prevent the BZCYYb1711 from exposure to the steam while presenting high performance. Such a core-shell structure confines the H₂O dissociation on the shell surface and enables the core to facilitate the reaction network expansion by protons migration (FIG. 1B). The conformal feature guarantees the easy electrode microstructure optimization via simple turning of the scaffold fabrication. Computational fluid dynamics (CFD) modeling on the PCEC air electrodes indicates the conformal coating-scaffold design of the air electrode can significantly boost the electrode performance. The electrolysis current of conformal coating-scaffold structure PCECs increases by ˜100% (FIG. 1C) compared to the traditional single-phase electrodes of identical microstructure and grain diameter. The increased performance mainly originates from the activation of the electrode within 10 um from the electrode/electrolyte interface, where the surface reaction rates of the conformal coating scaffold electrode increase sharply (5× slope compared to the traditional one) as approaching the electrode/electrolyte interface.

Barium doped Ruddlesden-Popper (R-P) phase Pr_{1.8}Ba_{0.2}NiO_{4.1} (PBNO) was evaluated as the conformal coating catalyst for the BZCYYb1711 scaffold. PBNO originates from the well-known triple-conducting R-P phase Pr₂NiO_{4+δ} (PNO), which received considerable interest recently due to its superior water-splitting activity and excellent tolerance against high steam vapor than alkaline-based perovskites, e.g. (Ba,Sr,La)(Fe,Co,Zn,Y) O_{3-δ}. The experimental study and density function theory (DFT) calculations described herein show that proper Ba replacement in the A-sites of PNO can surprisingly increase the hydration capability. As shown in FIG. 1D, the Ba-rich surface shows lower hydration energies compared to the Ba depleted surface. Besides, the cobalt-free Ln₂NiO_{4+δ} family (˜13−14×10⁻⁶K⁻¹) shows thermal expansion coefficients very close to Ba(Zr_{0.8-x-y}CeₓY_{y})O_{3-δ} (˜12−14×10⁻⁶K⁻¹). PCECs with this electrode is expected to provide excellent catalytic activity, exceptionally high durability in humified environments, and superior robustness in thermal cycling.

### Example 2: Results

### Thin Film Coating Fabrication on BZCYYb1711 Scaffold

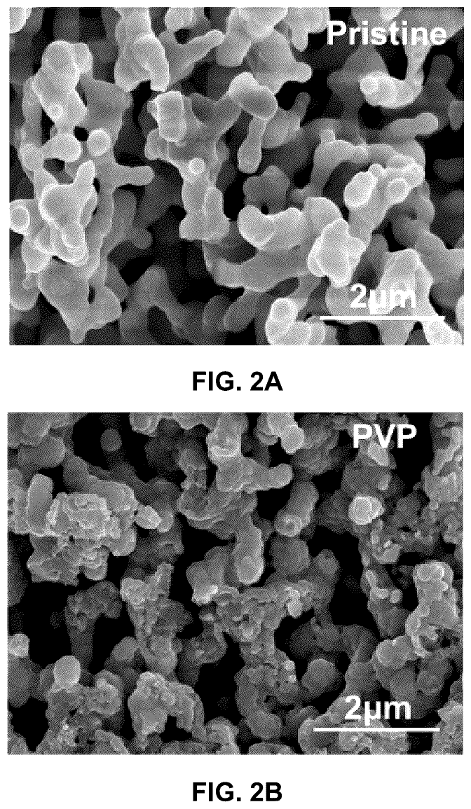

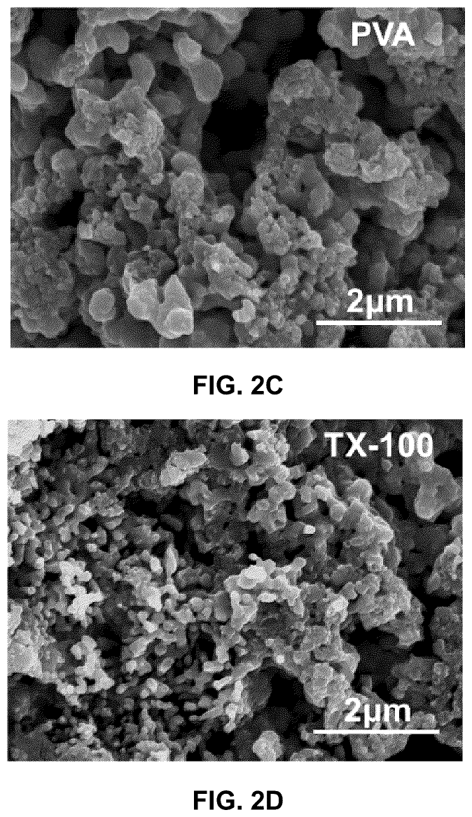

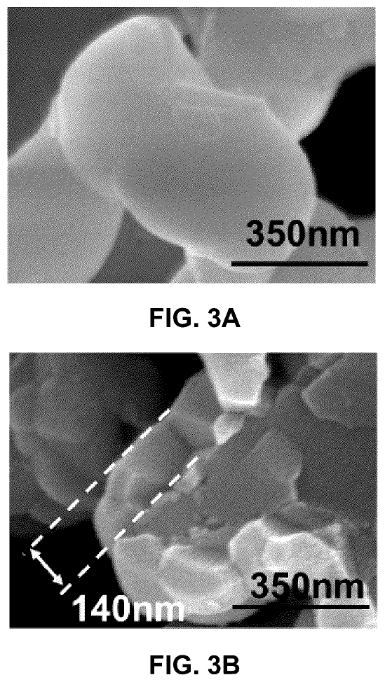

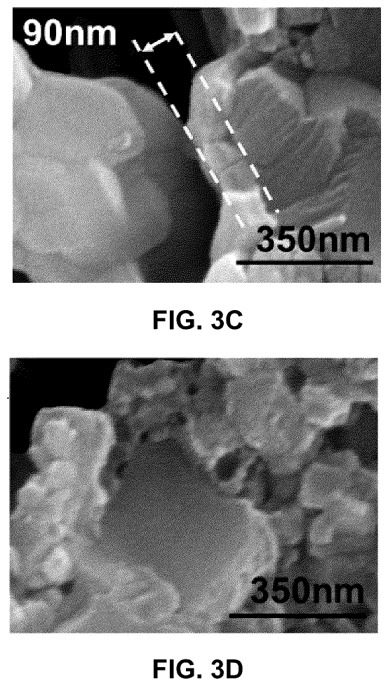

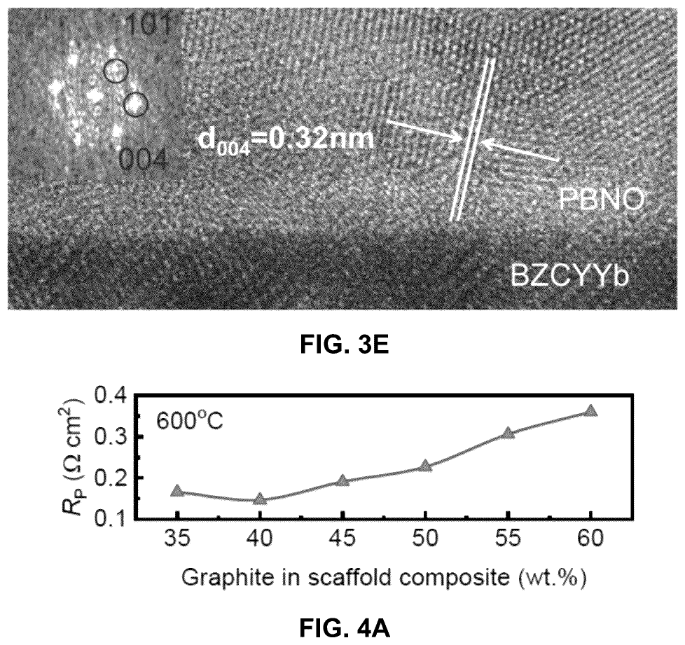

The thin-film coating of PBNO on a scaffold was achieved by the most simple and effective solution infiltration method. Surfactants play a critical role in wetting and emulsification 26. To achieve a dense conformal coating rather than a discrete coating, three kinds of surfactants, polyvinyl alcohol (PVA), polyvinyl pyrrolidone (PVP), and Triton-×100 (TX-100), were examined by infiltration with different surfactants on scaffold symmetrical cells to optimize the infiltration processes. Mesh-like BZCYYb1711 scaffolds were co-fired with electrolytes to construct a highly porous frame for infiltration. The surfactants concentration, cations concentration, chelating agent concentration, pH values, and catalyst loading were controlled consistently as 1 wt % of PBNO solution, 0.6 M, 0.9 M, 4, ˜50 vol. %, respectively. As shown in FIGS. 2A and 3A, the scaffold particles are well connected and uniformly distributed, providing good proton-conducting pathways. The infiltration process was repeated for 40 cycles, followed by sintering at 1000° C. for 2 h to reach a 50 vol % PBNO loading.

X-ray Powder Diffraction (XRD) results confirmed the formation of well crystalized PBNO phase on the BZCYYb1711 scaffold, indicating good chemical compatibility between these materials. FIGS. 2A-2D show the morphology of PBNO films coated on porous BZCYYb scaffolds using PBNO precursor solutions with different surfactants. PBNO film using PVP surfactant shows the desired conformal morphology with negligible PBNO agglomeration; PBNO film using PVA appears to be effective in forming a conformal film, and the microstructure from pristine scaffold is largely maintained after infiltration. However, obvious agglomeration of PBNO nanoparticles was observed, randomly filling the pores within the scaffold. The microstructure of the pristine BZCYYb scaffold can hardly be distinguished from the TX-1000 sample, whose morphology has already been completely changed with a tremendous amount of PBNO agglomeration. Cross-section images in FIGS. 3B-3D further confirmed the above infiltration results. A 140 nm dense, uniform, and conformal PBNO film is developed on the scaffold using PVP surfactant, close to the theoretical catalyst loading of 50 vol %. The PBNO film infiltrated by PVA surfactant is also dense and conformal; however, the thickness is only 90 nm, indicating that roughly ⅓ of the infiltrated precursors have become agglomeration phases. TX-100 cannot help develop a dense conformal coating on BZCYYb1711 scaffold, whose morphology is a combination of discrete coating and agglomeration. In addition, similar results of film formation were observed at the scaffold/electrolyte interface.

The transmission electron microscopy (TEM) and energy dispersive X-ray (EDX) analysis further confirmed the presence of a highly crystalline nature and homogenous element distribution (FIG. 3E). The diffraction planes with a crystal spacing of 0.32 nm, corresponding to PBNO (004), were demonstrated, agreeing well with that calculated based on the XRD. Since the PVP sample shows the best result in forming a well conformal film, it will be used in further electrochemical investigations on the performance and durability.

### Performance and Robustness of Conformal Coating Scaffold Electrode

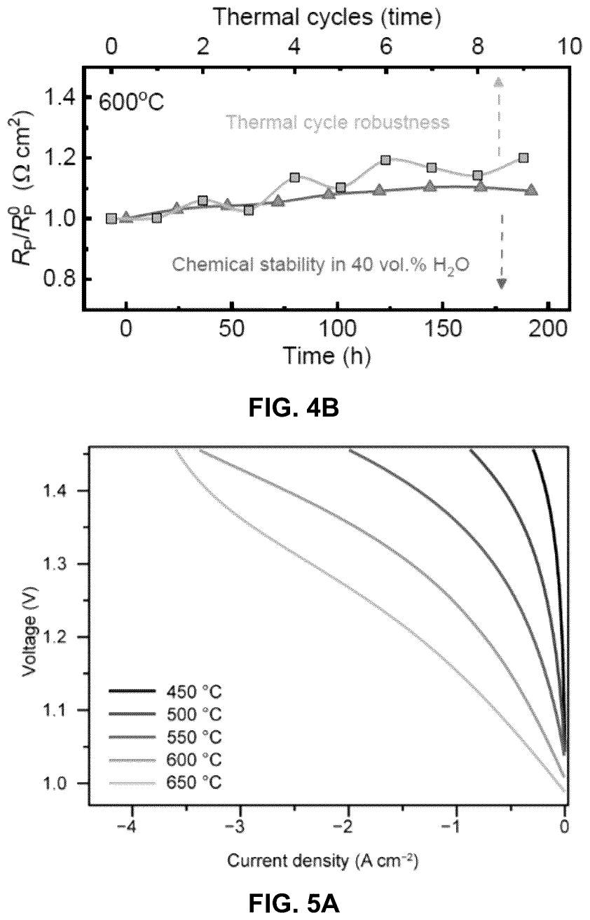

As shown above, the conformal coating scaffold electrode largely inherits the microstructure from scaffold, which is, the fabrication of pristine scaffolds controls the microstructure of the functional catalyst layer. Compared to the traditional electrode, whose microstructure optimization requires comprehensive exploration of powder properties and calcination steps, conformal coating electrodes can be easily optimized via simple turning the scaffold fabrication without compromising low-temperature calcination induced delamination and high-temperature structure coursing induced performance penalties. The coated catalyst layer will naturally inherit the structure tuning and mechanical strength from the scaffold regardless of catalyst layer fabrication. The microstructure of co-firing scaffold can be freely tuned by simply using different amounts or different types of pore formers. The optimum structural porosity of the PBNO conformal coating electrode was explored using symmetrical cells with varying levels of graphite (35, 40, 45, 50, 55, 60 wt %). As shown in FIG. 4A, the polarization resistance of symmetrical cells continuously decreases when the pore former is reduced from 60 wt % to 40 wt %. This is reasonable as a relatively denser scaffold can provide more ionic conductive pathways. In other words, it increases the effective conductivity of the scaffold. A more conductive scaffold will facilitate the expansion of reaction networks, enabling more active electrode surfaces. As the pore former continues to decrease, the polarization resistance of symmetrical cells grows up again. This could be caused by integrating individual grains during scaffold fabrication and infiltration, which decreases the specific surface area of PBNO film. An optimum polarization resistance of 0.148 Ω·cm² was achieved with 40 wt % graphite.

A short-term chemical stability test and thermal cycling test were conducted on symmetrical cells to examine the robustness of porosity optimized conformal coating scaffold electrode. In the short-term chemical stability test, a symmetrical cell was immersed into a 40 vol % H₂O-air environment for 200 hours, the cell gained a 10% increase in its polarization resistance in the first 100 hours and reached a relatively stable stage in the following 100 hours. As a comparison, the traditional single-phase PBNO symmetrical showed a two-stage exponential Rp growth, whose polarization resistance increased by 40% in the first 100 hours and 660% in the following 100 hours, resulting a is 8 times larger final polarization resistance. In the thermal cycling test, the sample was heated from 100° C. to 600° C. with a ramp rate of 20° C./min in dry air, then switched to a 40 vol % H₂O-air balanced environment followed by an impedance measurement after 2 hours equilibrium in the humified environment. After measurement, the sample was naturally cooled down within the furnace to 100° C. in dry air. The conformal coating symmetrical cell also presents outstanding thermal cycle robustness, only a slight increase in Rp was observed after each thermal cycle.

### Performance and Operational Stability of PCEC Utilizing Conformal Coating Scaffold Electrode Against High Steam Vapor Environment

FIG. 3A shows the electrochemical performance of the PCEC with a conformal coating scaffold electrode and BZCYYb1711 electrolyte operating at 450˜650° C. in electrolysis cell mode with pure hydrogen as fuel. At the applied voltage of 1.3 V, electrolysis current densities of 2.4 A·cm⁻², 1.46 A·cm⁻², and 0.68 A·cm⁻² were achieved at 650° C., 600° C. and 550° C., respectively. Compared with the results of PCECs, the performance of this PCEC in electrolysis ranks at one of the tops among PCECs operated at 600° C. and is comparable to the cells using a sophisticated electrode microstructure engineering, such as PLD, in-situ exsolution and 3D texture. Remarkably, its performance is several times higher than the electrochemical cells using other Ln₂NiO_{4+δ} materials as air electrodes but in traditional designs. For example, the electrolysis performance in the present work at 600° C. is nearly three times higher than the cell utilizing a single-phase Pr_{1.2}Sr_{0.8}NiO_{4+δ} air electrode (0.46 A·cm⁻² at 1.3 V) and two times higher than the cell with Pr_{1.7}Ba_{0.3}NiO_{4+δ}/BaZr_{0.1}Ce_{0.7}Y_{0.1}Yb_{0.1}O_{3-δ} composite electrode. The results are attributed to the excellent activation of the PBNO electrode with the assistance of a conductive scaffold, indicated by the model calculation. In fuel cell mode (FIG. 3B), peak power densities of 1050 mW·cm⁻², 665 mW·cm⁻², and 323 mW·cm⁻² were achieved at 650° C., 600° C., and 550° C., respectively. These promising results suggest that PBNO conformal coating scaffold electrode is active toward ORR and WOR. Judging from the electrochemical impedance spectra of R-PCEC measured under various operation conditions (applied bias), the electrolyte resistances largely contributed to 81%, 78%, and 60% of the ASR at a bias of 1.3 V at 600° C., 550° C., and 500° C. in the electrolysis mode, respectively. This suggests an electrolyte resistance dominating condition when these cells were operated at the thermal neutral voltage, indicating that the performance is able to be further increased by thinning the electrode thickness or increasing the conductivity.

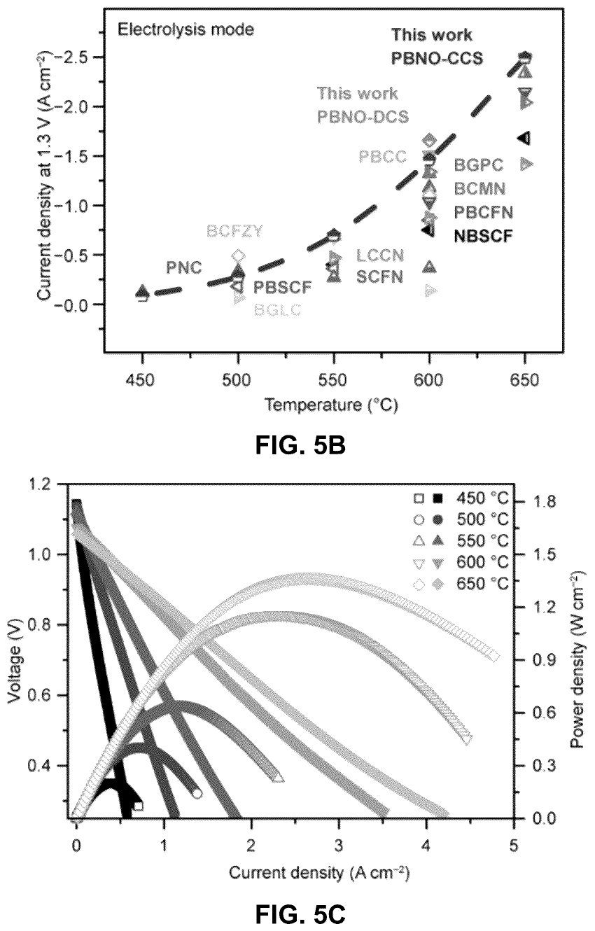

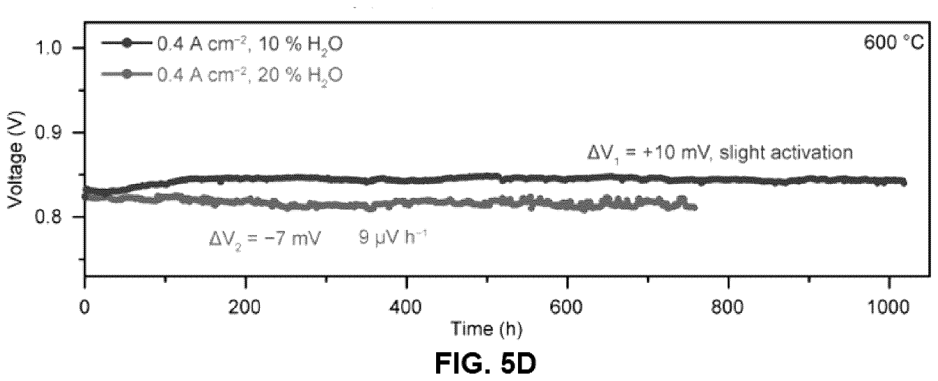

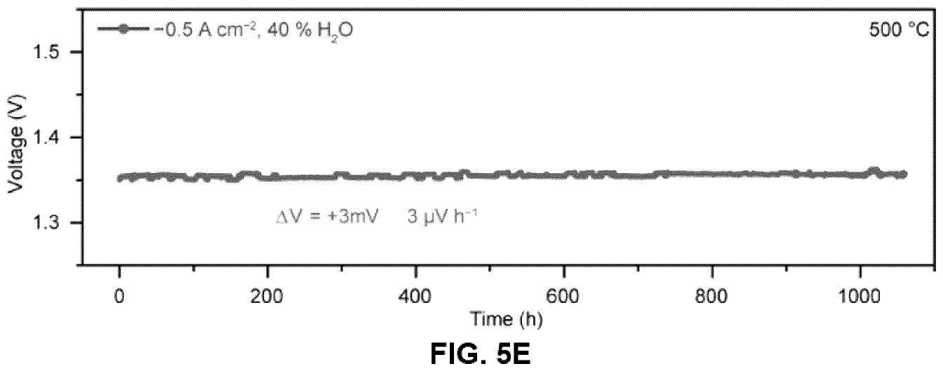

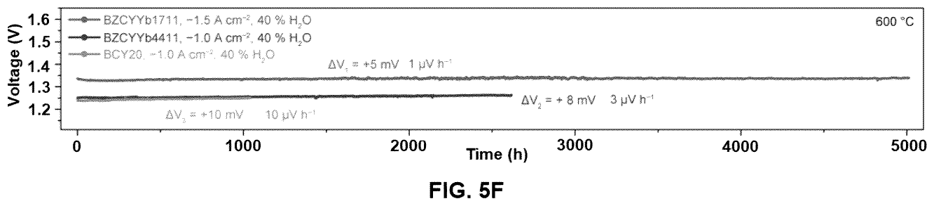

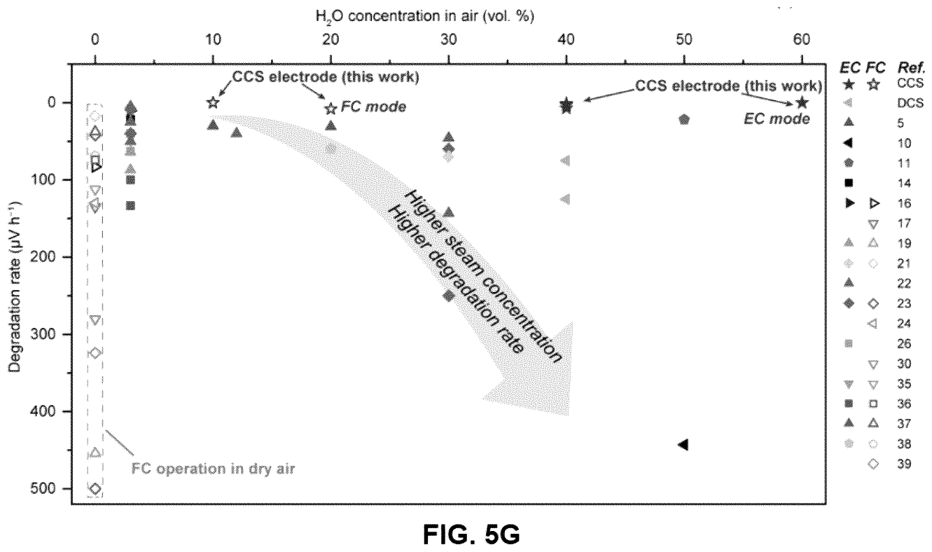

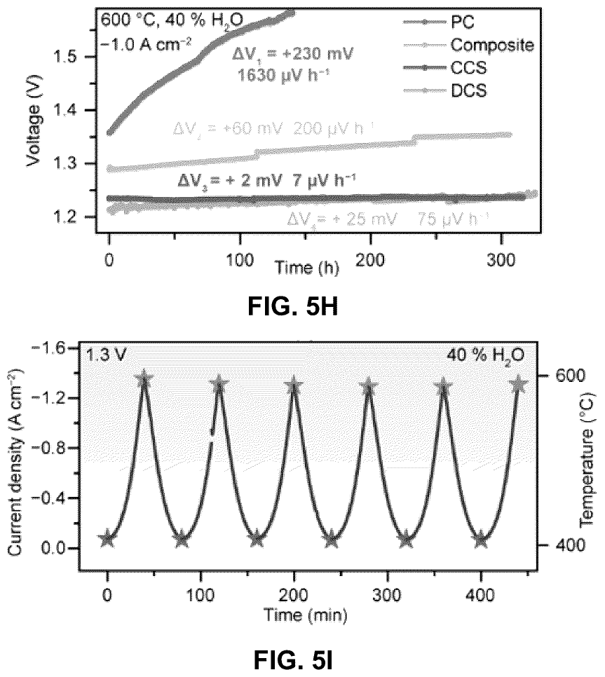

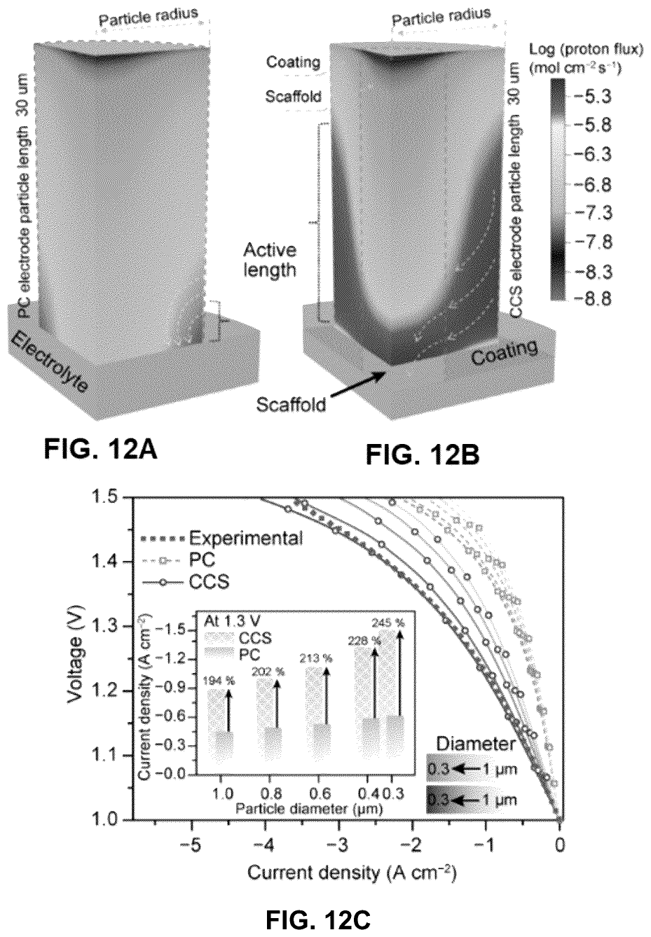

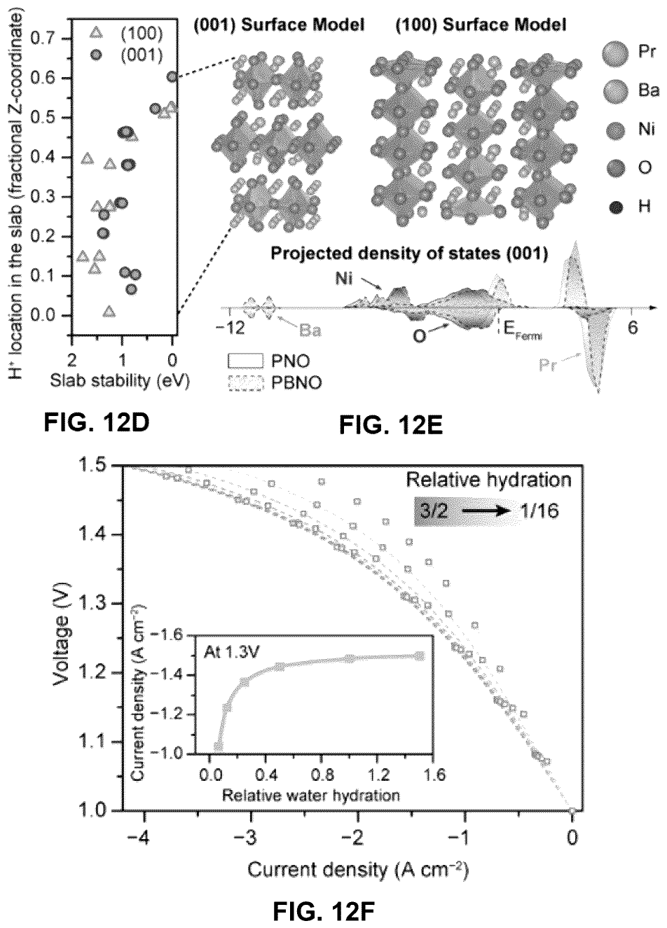

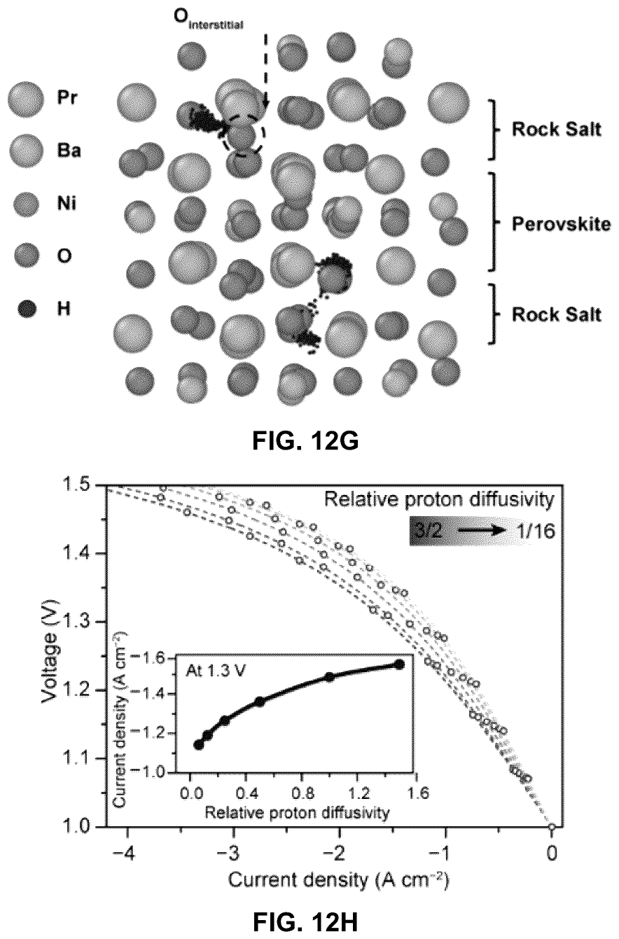

The electrochemical cells were operated in fuel cell mode with 10 vol % H₂O and 20 vol % H₂O in air electrode at 0.4 A·cm⁻², respectively, to examine long-term operational stability in fuel cell mode. As a result, required overpotentials for maintaining the current densities decreased by 10 mV after 760 hours of operation in 10 vol % H₂O-air and increased by 8 mV after 1000 hours of operation in 20 vol % H₂O-air, respectively, giving a 0.008 mV·h⁻¹ degradation rate in 20 vol % H₂O environment. The long-term operational stability in electrolysis mode was also examined in a 40% H₂O-air environment at 1.5 A·cm (FIG. 5E) and 1 A·cm. As shown in FIG. 5E, the cell was operated in electrolysis cell mode with 40 vol % H₂O in air electrode at 1.5 A·cm⁻², the required overpotentials for maintaining the current densities decreased during the first hundreds of hours, which may be attributed to the improved electrode surface as indicated by the impedance spectra and increased by 5 mV in the following 5000 hours operation, giving an overall degradation rate of 0.001 mV·h⁻¹ in 40 vol % H₂O. Compared to the state-of-the-art PCECs, the present PCECs demonstrate better durability in more severe conditions over long periods of operation. The excellent stability of the PCEC suggests that the conformal coating scaffold design is a highly effective strategy to achieve high-performance stability. To clearly show the significance of electrode design on the operational stability, another stability testing was performed by intentionally selecting cells with identical materials and identical initial performance but different electrode designs. Two PCECs with single-phase PBNO electrode and conformal PBNO coating scaffold electrode, respectively, running at 1 A·cm⁻², were compared. The PCEC utilizing conformal coating scaffold electrode, which does not have exposed vulnerable surfaces, presents extraordinary stability, while the PCEC single-phase electrode cell shows a 2 mV·h⁻¹ degradation rate. The thermal cycling durability of the cell was evaluated by measuring the current density at 1.3 V as the temperature changed periodically (FIG. 12D). After five cycles between 400° C. and 600° C. (10° C./min), the cell performance remained almost identical, indicating no delimitation or cracking during temperature change, which is due to the similar thermal expansion coefficients of PBNO and BZCYYb1711 and the massive well-bonded PBNO/BZCYYb1711 interface. promising potential for rapid start-up. The good thermal-mechanical strength enables the PCECs to be potentially used in rapid start-up devices.

### Self-Sustainable Reversible Operation of PCEC

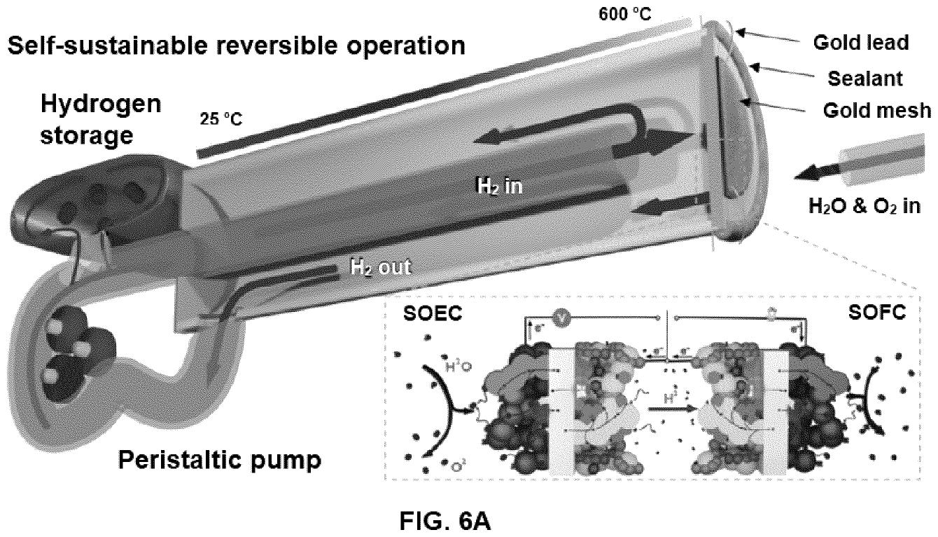

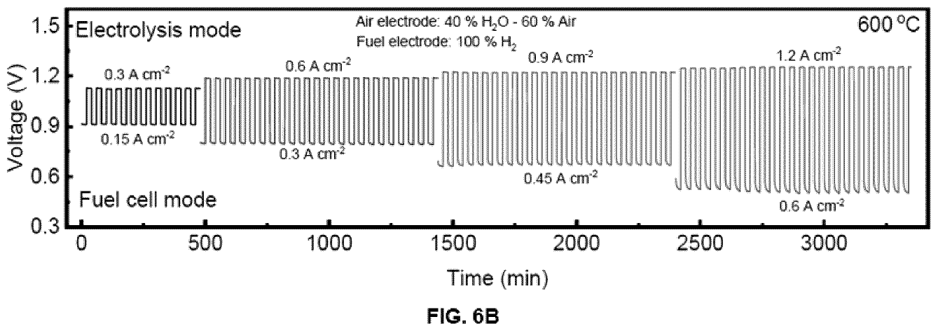

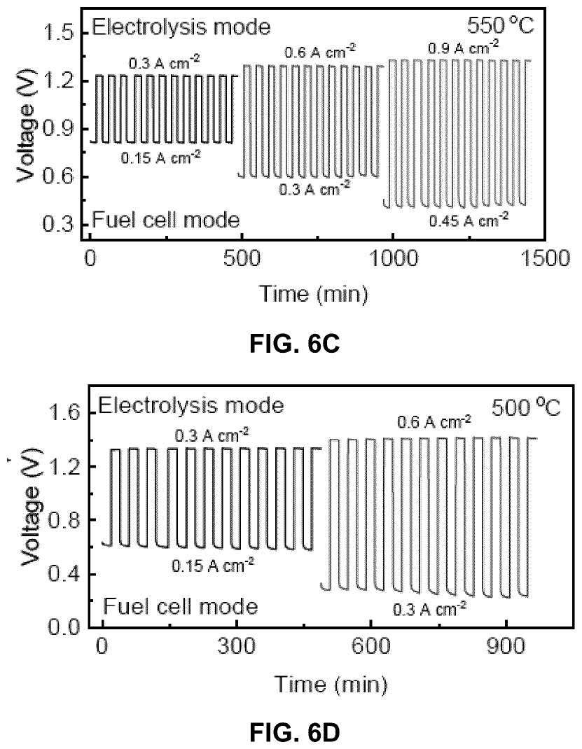

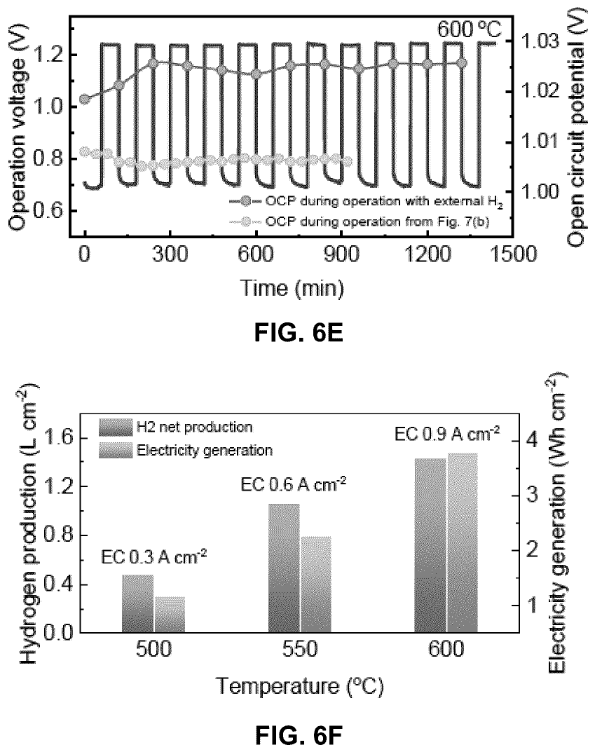

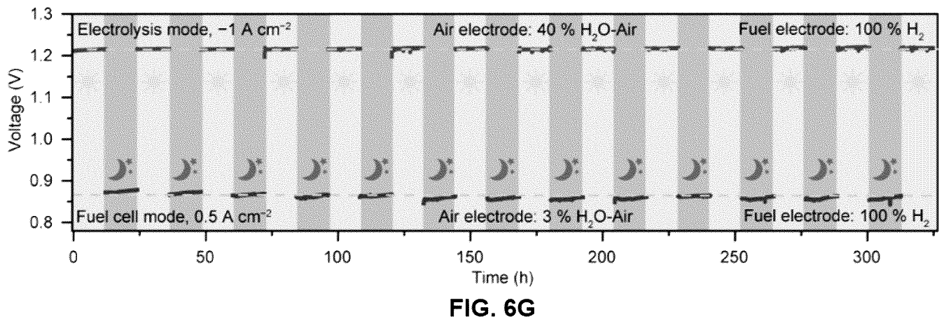

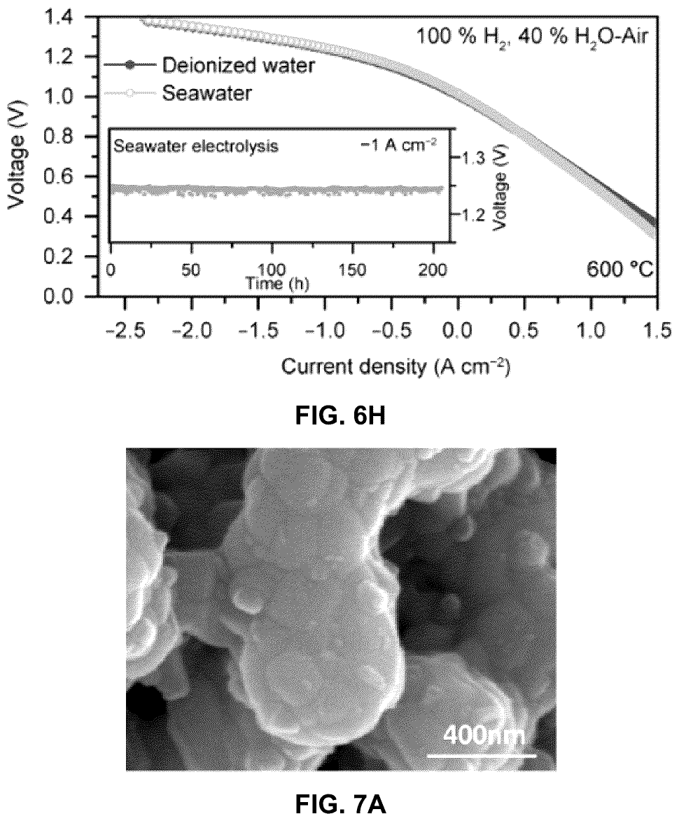

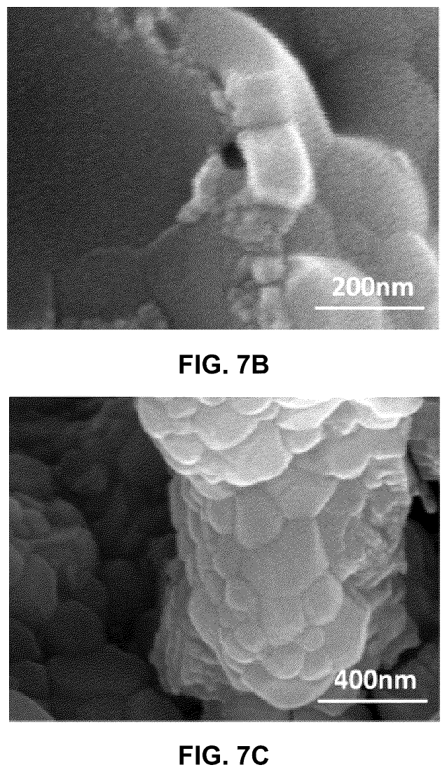

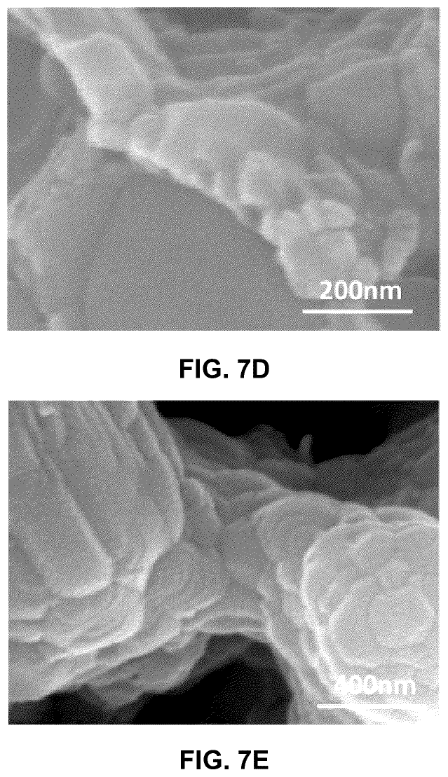

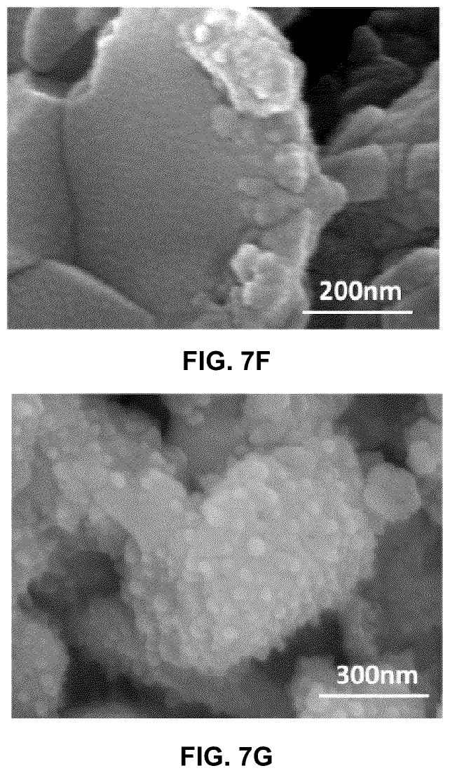

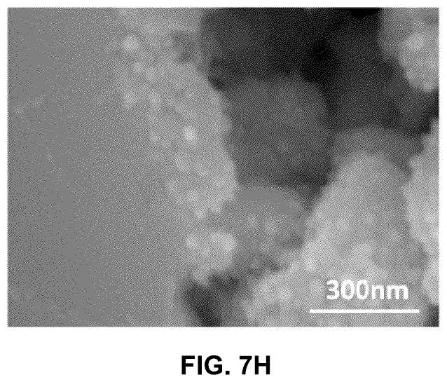

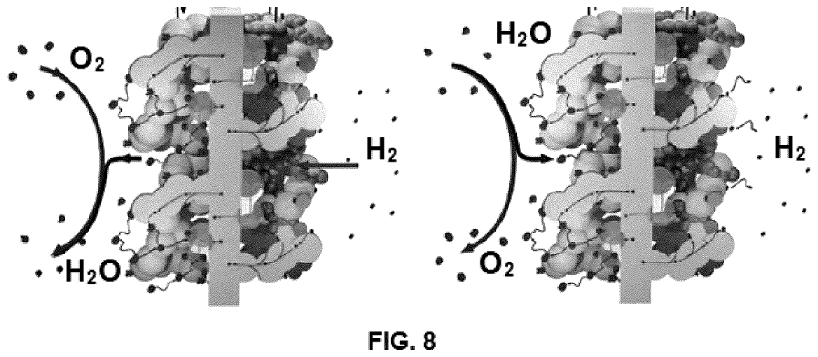

A hydrogen miniature circulation system (FIG. 7A) was designed and added to demonstrate self-sustainable reversible operation between water electrolysis and electricity generation (and electricity generation (respectively). The circulation system stores the hydrogen produced in electrolysis mode for electricity generation in fuel cell mode. Therefore, no continuous hydrogen supply is needed during the reversible operation. A series of cycling experiments were conducted at different temperatures and current densities to examine the reversibility of R-PCEC. FIG. 6B shows the switching of working mode between fuel cell mode and electrolysis mode at 600° C. The cell was first operated at a fuel mode with a constant current density for 20 minutes and then immediately switched to electrolysis mode with a constant current density for another 20 minutes. Compared to the reversible operations with continuous external H₂ supply in FIG. 7E, the reversible operations without external H₂ exhibit almost identical stability of cell voltage except for slightly lower open circuit potentials (OCP) during operation, which may be attributed to the limitation of the circulation apparatus. Similar results were observed when the temperature was decreased to 550° C. (FIG. 7C). The R-PCEC cycling under the same current densities showed similar behaviors and more stable overpotentials in fuel cell mode. Regardless of some small variation in cell voltage in the fuel cell mode when the temperature was further decreased to 500° C., the stable hydrogen and power generation at moderate current densities and temperatures suggest high reversibility of the R-PCEC with negligible negative effect from working mode switching, proving the potential of R-PCEC as renewable energy storage. The energy storage capability of the PCEC is evaluated by calculating its daily hydrogen production and electricity generation (FIG. 7F), assuming a 12 h-12 h reversible scheduling. Current density, faradic efficiency, and consumption in fuel cell mode are used to determine H₂ net generation in this reversible operation. The expected daily production yield are 476 mL·cm⁻², 1059 mL·cm⁻², and 1427 mL·cm⁻² at 500° C., 550° C., and 600° C., and the corresponding power generations are 1.15 Wh·cm⁻², 2.25 Wh·cm⁻², and 3.77 Wh·cm⁻², respectively, based on current electrolysis/fuel-cell pattern. Therefore, the results fully demonstrate the capability of this R-PCEC on reversibility operation to store and convert hydrogen fuel transiently.

### Comparison to Existing Electrodes

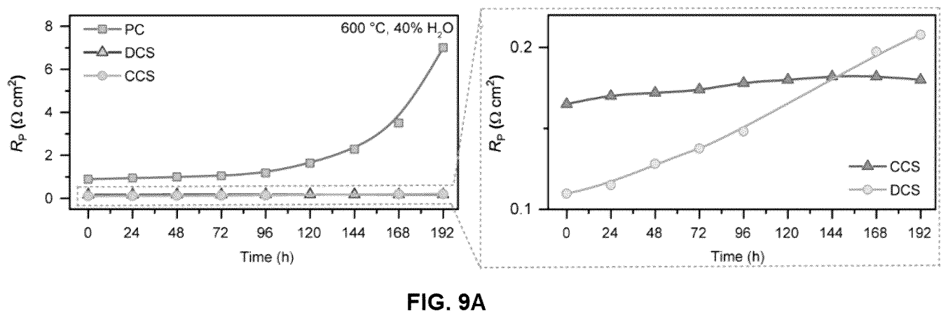

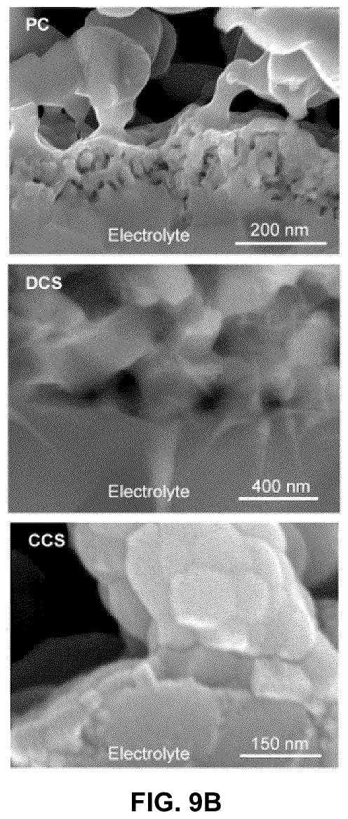

FIG. 9A compares the change of interfacial polarization resistance (Rp) of conformal coating scaffold electrode and traditional electrodes at 600° under the open circuit conditions (OCV). The conformal coating scaffold electrode (0.045% h⁻¹or 7.1×10⁻⁵ Ω·cm²·h⁻¹) shows orders of magnitude lower degradation rate than the discrete coating scaffold electrode (0.45% h⁻¹or 5×10⁻⁴ Ω·cm²·⁻¹) and single-phase electrode (3.44% h⁻¹); its Rp reached a relatively stable stage after the first 100 hours other than continuously increasing. FIG. 9B shows the cross-section morphologies of the electrodes after a stability test at 600° C. The formation of secondary particles can be clearly identified in the case of discrete coating scaffold electrode and single-phase electrode along the grain boundaries and electrode/electrolyte interface, conformal coating scaffold electrode shows a clean surface and interface after the same test. The conformal coating scaffold design also provides excellent thermal mechanical strength. Due to the well connection of PBNO to the electrolyte via scaffold-electrolyte integration, conformal coating scaffold electrode presents outstanding thermal shock resistance; only minor increases in Rp were observed.

### Example 3: Discussion

There is always a tradeoff between conductivity/activity and stability when developing stable high-performance air electrodes and it becomes difficult when compromises need to be made on both electrolyte materials and electrode materials in traditional electrode design. A conformal coating electrode design can effectively ease the difficulty of achieving stable high-performance PCECs. The elimination of chemical vulnerable high conductivity electrolyte exposure from a high steam environment enables the possibility of solely optimizing the material properties of TCOs when developing a triple conducting air electrode for PCECs. FIGS. 7A-7H shows the cross-section morphology of BZCYYb1711 scaffold and PBNO film before and after 300 h, 1000 h, and 5000 h operation in a 40 vol % H₂O environment. Although these coating layers have already gone through different levels of nano-scale surface morphology change, they maintain conformal and dense structure after continuous operations. The scaffold and PBNO coating show good interfacial bounding, and no trace of BZCYYb1711 decomposition or film delamination was observed, which demonstrates the liberation of the BZCYYb1711 from reaction/conduction to conduction alone.

Most of the PCECs in this work show certain activation levels during the first 500 hours and subsequent continuous degradation in a high H₂O environment. The degradation of materials during heterogeneous catalysis in extreme conditions is experimentally common. In the present study, high operation current densities and concentrated H₂O will technically cause high surface exchange rates, which may shift the material status permanently from its initial state that formed during fabrication in an H₂O-free environment. There are many reasons for catalytic performance degradation, chemically or physically. The morphology images in FIGS. 7A-7B show that the coated PBNO films seem to have a continuous surface reconstruction that breaks the PBNO grain into smaller pieces. The initial status of PBNO crystal grain is round and smooth. After the 300 h test, the PBNO crystal grain seems to split along definite crystallographic planes. The change in grain morphology became more evident over time, as observed from the images of samples after the 1000 h and 5000 h of operations. The typical grain size of PBNO film is merely 20-30 nm after 5000 h of operation, and it is 5 times smaller than the regular 100 nm grain size of the sample before operation.

To confirm such “cleavage” of crystals that may be responsible for the activation and degradation, a porous PBNO pellet that has a large grains size of ˜1 um was fabricated and annealed in a 40 vol % H₂O environment. After 200 h annealing, the PBNO presents similar “cleavage” along some crystallographic structural planes. Generally, the round and smooth polycrystal grain have no clear preference in exposed crystalline. The reconstruction will make specific energy-stable crystal plains exposed to the humified environment, thus bringing in preferred crystalline termination in high H₂O environments. According to the DFT calculation, the surface reaction and diffusion are sensitive to different crystalline terminations (configuration dependent). Therefore, as the reconstruction happens, the electrode may first benefit from increased surface area from smaller grain size while suffer from the decreased surface-active site density after the reconstruction exceeds a certain threshold limit. The impedance spectra of the PCEC after 200 h, 1000 h, 300 h and 500 h operations were processed using the distribution of relaxation time (DRT) to explore the operational degradation mechanism of PBNO coating. By referring to a previous study on the electrochemical responses of Ba doped PNO in humified environment, it was found that the O-related elementary step, reduction of surface oxygen ion, is responsible for electrode degradation in a highly humified environment. The resistance of this elementary step increased from 0.143 Ω·cm² to 0229 Ω·cm² after 4800 h of operation, which corresponds with the material change toward more hydroxyl-stable surfaces and less surface-active site for O-related species in a high H₂O environment. Also, some molecular chemisorption peaks merged, which may be related to the surface hydroxylation (hydroxides are proton conductors) that alters the surface adsorption layer. Fortunately, the reconstruction is only physical change of the crystal rather than a chemical decomposition as confirmed by the XRD (to be added) and the effect of reconstruction on performance degradation is as low as 0.001 mV·h⁻¹.

In summary, experimental characterizations have confirmed the success of conformal coating scaffold electrode design during 5000 hours of operation. The electrochemical cells maintained superior performances during operation at intermediate temperatures. Naturally or thermodynamically favored adapting of PBNO film in highly humified environments is observed, which is responsible for the activation and degradation of PCECs during operation.

### CONCLUSION

An active and robust PBNO-BZCYYb1711 conformal coating scaffold electrode has been developed with the help pf CFD calculation and DFT calculation for proton-conducting electrolysis cells. The electrode can be fabricated and optimized easily and inexpensively via simple procedures. Various measurements on symmetrical and electrochemical cells indicate excellent chemical stability and promising thermal cycling robustness for practical operating, which is a huge leap compared to traditional single-phase electrodes. PCEC equipped with this electrode demonstrates 1.46 A·cm⁻² under 1.3 V in electrolysis cell mode and 665 mW·cm⁻² in fuel cell mode at 600° C. Long term operations were conducted in fuel cell mode and electrolysis mode. PCECs equipped with conformal coating scaffold electrodes show an extremely low overall degradation rate of 0.001 mV·h⁻¹ in 5000 hours of electrolysis operation in a 40 vol % H₂O environment and an 0.008 mV·h⁻¹ degradation rate in 1000 hours fuel cell operation in 20 vol % H₂O environment. In addition, the self-sustainable reversible operation is successfully demonstrated by hydrogen self-circulation without external hydrogen addition. Post-mortem analysis suggests that the conformal coating scaffold design is ideally suited for long-term steam electrolysis in highly humified environments. This work demonstrates that the rational designed conformal coating scaffold electrode could be a guideline for other electrochemical systems, and the potential of self-sustainable PCEC for low-cost and efficient renewable energy storage.

In summary, herein is demonstrated a holistic mitigation strategy to comprehensively address the issues of limited operational stability in high-concentration steam, electrode/electrolyte interfacial contact, and proton transport for PCECs. The present approach involves constructing a porous electrolyte scaffold and conformally coating it with steam-resistant and active PBNO oxygen electrocatalyst which can stabilize a family of doped barium cerate-based proton conducting electrolytes. The developed CCS cells exhibit high chemical stability against H₂O, strong PBNO/electrolyte interfacial contact bonding, percolated proton conducting network, and thermomechanical stability against temperature fluctuation. This CCS design can hermetically blanket the vulnerable electrolytes with a protective coating layer of PBNO to potentially isolate them from steam, accommodate drastic volume changes, alleviate the strain, and establish the proton conducting network with significantly expanded active regions to circumvent decomposition and delamination and enhance the ECSA and proton transport kinetics. The PCEC delivers a peak power density of 1160 mW cm⁻² and electrolysis current density of −1.73 A cm⁻² at 600° C. under optimal conditions. Above all, this CCS microstructure design enables PCEC to reach a record-high 5000-hour electrolysis stability at −1.5 A cm⁻² and 600° C. in 40% H₂O leading to an extremely low degradation rate of 1 μV h⁻¹ and achieve exceptional fuel cell operation stability for 1000 h without degradation. The developed UR-PCEC system demonstrates high resilience and stability under both frequent EC/FC switching and harsh long-duration deep cycling conditions without external H₂ supply, with great potential for smoothing grid variations and managing long-duration energy storage and electricity supply. It shows a lower LCOH than state-of-the-art PCECs and O-SOCs due to its unprecedent electrolysis operation stability. Multiscale multiphysics modeling combining the microkinetic CFD simulations and DFT calculation maps out the relationship between microstructure (grain size), material properties (hydration and proton diffusivity) and electrochemical performance by linking the atomic scale processes to micro/macro scale phenomena. The rational design protocol, in-depth mechanistic understanding, and demonstrated prototype system may help to develop viable UR-PCECs into the sustainable energy infrastructure for energy storage. This general design strategy also has implications for applications in solid-state batteries, heterogeneous catalysis, and other ceramic-based energy devices.

### Example 4: Materials and Methods

### Materials Synthesis and Preparation of Water-Based Catalyst Solution for Infiltration

Ruddlesden-Popper phase air electrode materials Pr_{1.8}Ba_{0.2}NiO_{4.1} and BaZr_{0.1}Ce_{0.7}Y_{0.1}Yb_{0.1}O_{3-δ} electrolyte powders and perovskite phase electrolyte materials BaZr_{0.1}Ce_{0.7}Y_{0.1}Yb_{0.1}O_{3-δ} were synthesized by ethylenediaminetetraacetic (EDTA)-citric sol-gel method. During synthesis, citric acid and stoichiometric nitrates were first dissolved into distilled water. EDTA as a complexing agent was dissolved into diluted ammonia water. The mole ratio of metal cation: citric acid: EDTA was set to 1:1.5:1. The nitrate and EDTA solutions were then mixed together, followed by adjusting the pH value to 8-10 using ammonia water or nitric acid. Afterward, the solution was held at ˜80° C. and stirred until gelation on a magnetic heating plate. The gel was heated at 500° C. in the air to decompose nitrates and residual organics. The resultant PBNO powders were calcined in air at 1150° C. for 4 h, BZCYYb powder in air at 1100° C. for 8 h. Calcined powders were ball-milled in a planetary miller for 12 h.

The PBNO series aqueous solution with a metal cation (Pr+Ba+Ni) concentration of 0.6 M (mol/L) was prepared by dissolving stoichiometric nitrates together with glycine as a chelating agent in water at room temperature. Polyvinyl pyrrolidone (PVP), Polyvinyl alcohol (PVA) and Triton X-100 were used as surfactants, respectively. The pH value of different PBNO solutions was finally adjusted to 4 before use.

### Fabrication of Symmetrical Cells

To make PBNO∥BZCYYb1711∥PBNO single-phase symmetrical cells, a proportional amount of Zn (NO₃)₂ ethanol solution was added to BZCYYb1711 powders at a ZnO (sintering aid): BZCYYb1711=1:100 weight ratio, then dried at 220° C. overnight; The electrolyte powders were then pressed to pellets in a 16 mm die at 300 MPa and sintered in air at 1300° C. 4 h for electro pellet support. Single-phase PBNO were blended in an ink vehicle (Fuel Cell Materials Co.), then ground in a mortar until a homogeneous air electrode slurry was formed. The air electrode slurry was then symmetrically screen-printed to the BZCYYb1711 electrolyte with an area of 0.3 cm², followed by sintering at 1150° C. for 3 h. Au paste was applied to the air electrode and fuel electrode as the current collector. Silver wire was used as the lead wire.

The PBNO∥BZCYYb1711∥PBNO conformal coating scaffold and discrete coating scaffold symmetrical cells were made via water-based solution infiltration on scaffold symmetrical cells. The PBNO series aqueous solution with a metal cation (Pr+Ba+Ni) concentration of 0.6 M (mol/L) was prepared by dissolving stoichiometric nitrates together with glycine as a chelating agent in water at room temperature. 1 w % of polyvinyl pyrrolidone (PVP) and Triton X-100 were used as surfactants, respectively. The pH value of different PBNO solutions was finally adjusted to 4 before use. The scaffold symmetrical cells were fabricated by co-firing of electrolyte pellet and scaffold. After pressing the electrolyte powders into pellets in a 16 mm die at 300 MPa, a BZCYYb1711 scaffold slurry was screen-printed to the BZCYYb1711 electrolyte. The printed samples were sintered at 1300° C. for 4 h. The scaffold slurry was prepared by blending the mixed graphite/BZCYYb powders (various wt. ratios) in an ink vehicle. After fabricating the scaffold symmetrical cells, the infiltration solution with PVP was dropped into the as-prepared porous scaffold to produce conformal coating and the infiltration solution with Triton X-100 used to produce discrete coating. The amount of solution drop was preciously controlled by a micro syringe. After 35 drops of the solution, the result samples were calcinated at 1100° C. for 3 h to give coated scaffold symmetrical cells.

PBNO∥BZCYYb1711∥PBNO conformal coating scaffold and discrete coating symmetrical cells were fabricated by co-firing of electrolyte pellet and scaffold. After pressing the electrolyte powders into pellets in a 16 mm die at 300 MPa, a BZCYYb1711 scaffold slurry was screen-printed to the BZCYYb1711 electrolyte. The printed samples were sintered at 1300° C. for 4 h. The scaffold slurry was prepared by blending the mixed Graphite/BZCYYb powders (various wt. ratios) in an ink vehicle. The infiltration solution was dropped into the as-prepared porous scaffold, whose amount was preciously controlled by a micro syringe, and calcination at 1000° C. for 2 h to give conformal coated symmetrical cells. The area of BZCYYb1711 scaffold after sintering is 0.3 cm².

Electrochemical cells were fabricated with a fuel electrode support ∥ BZCYYb1711 electrolyte∥ air electrode structure. Fuel electrode support powders of NiO:BZCYYb: starch (5:5:2 wt. ratio) were mixed thoroughly. Mixed NiO/BZCYYb powders (6:4 wt ratio) was blended with the ink vehicle to form fuel electrode function slurry. BZCYYb1711 electrolyte powder with 1 wt % ZnO sintering aid was blended with the ink vehicle to form electrolyte slurry. 0.5 g fuel electrode support powders were pressed to pellets at 200 MPa in the 16 mm die, then spin-coated with one layer of fuel electrode function and two layers of electrolyte slurry. PBNO slurry was screen-printed to the electrolyte with an area of 0.32 cm², followed by sintering at 1150° C. for 2 h to yield single-phase PBNO PCEC. The conformal coating scaffold PCEC was prepared via the same route as the symmetrical cell fabrication. The area of conformal coating scaffold electrode after co-sintering is 0.207 cm². Au paste was applied to the air and fuel electrodes as the current collector. The gold wire was used as lead wire.

### Process for Fabrication of Conformally Coated Scaffold (CCS) Based Symmetric Cells

The CCS based symmetric cells in a configuration of PBNO|BZCYYb1711 scaffold |dense BZCYYb1711|BZCYYb1711 scaffold |PBNO were prepared by a process consisting of electrolyte scaffold fabrication and wet-chemistry infiltration. The porous electrolyte scaffold on the dense electrolyte pellet was fabricated by a co-firing process. First, the BZCYYb1711 powder was mixed with a given amount of Zn(NO₃)₂ and polyvinyl butyral (PVB)-ethanol solution at a weight ratio of ZnO (sintering aid): BZCYYb1711:PVB=1:100:3. Then, the mixture suspension was dried in air at 120° C. overnight. The dry powder was then pressed in a 16 mm die at 300 MPa to yield dry pressed BZCYYb1711 pellets. The scaffold slurry was prepared by mixing the powders of BZCYYb1711 and pore former graphite with varying weight percentages in an ink vehicle (Fuel Cell Materials Co.). The optimal percentage of graphite in the mixture powder was 40 wt. %. Then, the scaffold slurry of BZCYYb1711 and graphite was screen-printed onto pressed BZCYYb1711 pellets for both sides. The pellets with both sides coated with the scaffold slurry were sintered at 1300° C. in air for 4 h to produce the electrolyte scaffold pellets consisting of porous BZCYYb1711 scaffolds on both sides of dense BZCYYb1711 electrolytes. Subsequently, the scaffold was conformally coated through an infiltration process. The precursor aqueous solution with a concentration of 0.3 M for total metal cations (Pr+Ba+Ni) was prepared by dissolving stoichiometric metal nitrate salts in deionized water with glycine as a chelating agent. polyvinylpyrrolidone (PVP) was used as a surfactant and added into the precursor solution with a concentration of 1 wt. %. The pH value of the precursor solution was adjusted to 4. Afterwards, the precursor solution was dropped and infiltrated into the as-prepared porous scaffolds for both sides. The amount of precursor solution drop was preciously controlled by a pipette. 0.5 μL of precursor solution was dropped each time. After 35 drops of the solution, the resultant sample was calcined at 1050° C. for 3 h to produce a CCS based symmetric cell. Au paste was applied to both sides as the current collectors and Au wires were used as lead wires.

### Fabrication of Discretely Coated Scaffold (DCS) Based Symmetric Cells

The fabrication of DCS based symmetric cells was similar as the above-mentioned process except that Triton X-100 was used instead of PVP in the infiltration step.

### Fabrication of Planar-Contact (PC) Based Symmetric Cells

The PC based symmetric cells in a configuration of PBNO |dense BZCYYb1711| PBNO were prepared by a common fabrication process for protonic ceramic electrochemical cells (PCECs). First, the BZCYYb1711 powder was mixed with a given amount of Zn(NO₃)₂ and polyvinyl butyral (PVB)-ethanol solution at a weight ratio of ZnO (sintering aid):BZCYYb1711:PVB=1:100:3. Then, the mixture suspension was dried in air at 120° C. overnight. The dry powder was then pressed in a 16 mm die at 300 MPa to yield dry pressed BZCYYb1711 pellets. The pressed pellets were sintered in air at 1300° C. 4 h to form dense electrolyte pellet supports. Then, the PBNO powder was mixed in an ink vehicle and ground in a mortar until a homogeneous slurry was obtained. The PBNO electrode slurry was then screen-printed onto both sides of the as-prepared dense BZCYYb1711 electrolyte pellet with an electrode area of 0.316 cm², followed by sintering at 1100° C. for 3 h. Au paste was applied to both sides as the current collectors and Au wires were used as lead wires.

### Fabrication of PBNO-BZCYYb1711 CCS Based Full Cells

The full cells were fabricated with a structure of fuel electrode support| dense BZCYYb1711| BZCYYb1711 scaffold| air electrode. The fuel electrode support powders of NiO, BZCYYb1711, and starch were mixed with a mass ratio of 5:5:2. Then, NiO and BZCYYb1711 powders were mixed with a weight ratio of 6:4 and blended with the ink vehicle to form the fuel electrode function slurry. BZCYYb1711 was mixed with sintering aid ZnO (1 wt. %) and blended with the ink vehicle to form the electrolyte slurry. 0.5 g of fuel electrode support powders were pressed to pellets at 200 MPa in a 16 mm die. Then, one layer of fuel electrode function and two layers of electrolyte slurry were sequentially coated on the fuel electrode support through a spin-coating process. After pressed at 300 MPa again, the scaffold slurry of BZCYYb1711 and graphite was screen-printed onto the top electrolyte layer with a scaffold area of 0.316 cm². The pellets were sintered at 1300° C. in air for 4 h. Subsequently, the scaffold was conformally coated by PBNO through an infiltration process in a similar way. The geometric area of PBNO air electrode after sintering was 0.2 cm². Au paste was applied to the air and fuel electrodes as the current collectors and the gold wires were used as lead wires.

PBNO-BZCYYb4411 CCS and PBNO-BCY20 CCS based full cells were fabricated in a similar way except for the use of BZCYYb4411 and BCY20 to replace the BZCYYb1711.

### Characterization

The phase purity was examined by X-ray diffraction (XRD, PANalytical X'pert PRO, Cu Kα radiation). The microstructure of samples was examined by scanning electron microscopy (SEM, Hitachi S-4700) and Transmission electron microscopy (TEM, Talos F200X G2). Electrochemical measurements were carried out using Gamry Interface 5000. Impedance was collected over the frequency range from 1 MHz to 0.1 Hz with an AC perturbation of 3 mA. Atmospheres were created via mass flow controllers (Alicat Scientific) and a temperature-controlled 30 L water bubbler with relevant carry gas.

### Unitized Regenerative Operation

The unitized regenerative PCEC (UR-PCEC) prototype system was constructed by integrating a CCS-based PCEC with H₂ circulation and storage functional auxiliary units, which demonstrated the unitized regenerative self-sustainable operation without external H₂ supply under both frequent EC/FC alternation and harsh long-duration operation conditions. The circulation and storage functional auxiliary system consisted of a gas sampling bag (Restek Multilayer sealing bag) for H₂storage, and a peristaltic pump (100 sccm) for circulating the H₂ flow. The operation of the UR-PCEC was switched between the electrolysis cell (EC) mode and fuel cell (FC) mode at different current densities and temperatures.

### Example 5: Design Principles

To achieve high activities and exceptional stability for oxygen reduction (ORR) and evolution (OER) reactions, in addition to a strong and extended electrode/electrolyte interfacial contact in PCECs, it is proposed that the surfaces of porous and percolated electrolyte scaffold and dense electrolyte should be coated with an ideal electrocatalyst that meets several criteria. (i) It must have high intrinsic chemical stability against steam. (ii) It should be chemically compatible with the electrolyte without interdiffusion and interfacial reactions. (iii) It should have a sufficient triple conductivity. (iv) It should form a conformal dense coating layer that is impervious to steam and sufficiently thin to reduce the diffusion distances of ions and electrons. (v) It should maintain long-term electrode-electrolyte interfacial stability. (vi) Its TEC should match that of the electrolyte. (vii) It should have favorable thermomechanical stability. (viii) It should possess sufficient electrocatalytic activities and high kinetics for OER and ORR. (ix) It should have outstanding hydration capability for proton incorporation and diffusion. (x) It is preferably cobalt-free, as the critical element Co may increase the cost, lead to unmatched TECs with many electrolytes, and reduce the chemical stability despite the potential high activities of Co-containing oxygen electrodes.

FIG. 10A illustrates the proposed novel PCEC fabrication approach in comparison with a traditional screen-printing process. The proposed strategy consists of porous electrolyte scaffold preparation and wet-chemistry infiltration. The porous scaffold, composed of interconnected electrolyte particles, is first integrated with the sintered dense electrolyte to form a robust and continuous proton conducting network acting as a backbone for loading the TCO electrocatalyst. Then, an aqueous precursor solution containing soluble metal salts, chelating agent and surfactant molecules is infiltrated into the porous scaffold. After heating, the TCO electrocatalyst is formed and coated on the electrolyte scaffold surface. In this work, the conformally coated scaffold (CCS) and discretely coated scaffold (DCS) were obtained by judicious selection of infiltrating surfactant molecules to regulate the wettability. In the CCS, the TCO serves as a continuous film to conformally coat both the porous electrolyte scaffold and dense electrolyte underneath, which can hermetically blanket the electrolyte as a protective layer to potentially isolate the vulnerable electrolyte from steam. This architecture confines the H₂O dissociation on the TCO surface and enables the inner electrolyte scaffold to expand the proton conducting network. For comparison, discrete TCO electrocatalyst particles are immobilized on the surface of DCS, which may extend the active length of TPB but cannot prevent the exposure of electrolyte to the steam.

### Material Characterizations

Here, it is demonstrated that Pr_{1.8}Ba_{0.2}NiO_{4.1} (PBNO) as a stable and active oxygen electrocatalyst meets those criteria. PBNO can be conformally coated on the porous doped barium cerates-based electrolyte scaffolds, leading to high stability of PCECs against high-concentration steam under industrially relevant harsh operational conditions. A commonly used proton-conducting electrolyte material BZCYYb1711 was found to have intrinsic chemical instability against H₂O, which was easily decomposed in liquid water and steam at elevated temperatures. Previous computation results demonstrated that the rare-earth sites of doped barium cerates are vulnerable to H₂O, which causes the instability of BZCYYb1711. A representative benchmark oxygen electrocatalyst, PrBa_{0.5}Sr_{0.5}Co_{1.5}Fe_{0.5}O_{5+δ} (PBSCF), also showed moderate decomposition in H₂O. This agrees with a tendency of exsolution and segregation occurring in many Co-rich perovskite oxides. Therefore, the intrinsic chemical instability of BZCYYb1711 and PBSCF against H₂O and the inevitable exposure of BZCYYb1711 electrolyte to the steam in the conventional screen-printed planar-contact (PC) and composite cells configuration impair the long-term operational stability of PCECs. In contrast, PBNO demonstrated extraordinary chemical stability without decomposition even under harsh hydrothermal and long-time annealing conditions, confirmed by ex-situ and in-situ X-ray diffraction (XRD) patterns and Raman spectra. PBNO also showed excellent chemical compatibility with BZCYYb1711 in the CCS and DCS after annealing at 1050° C., retaining their individual Ruddlesden-Popper and perovskite phases, respectively.

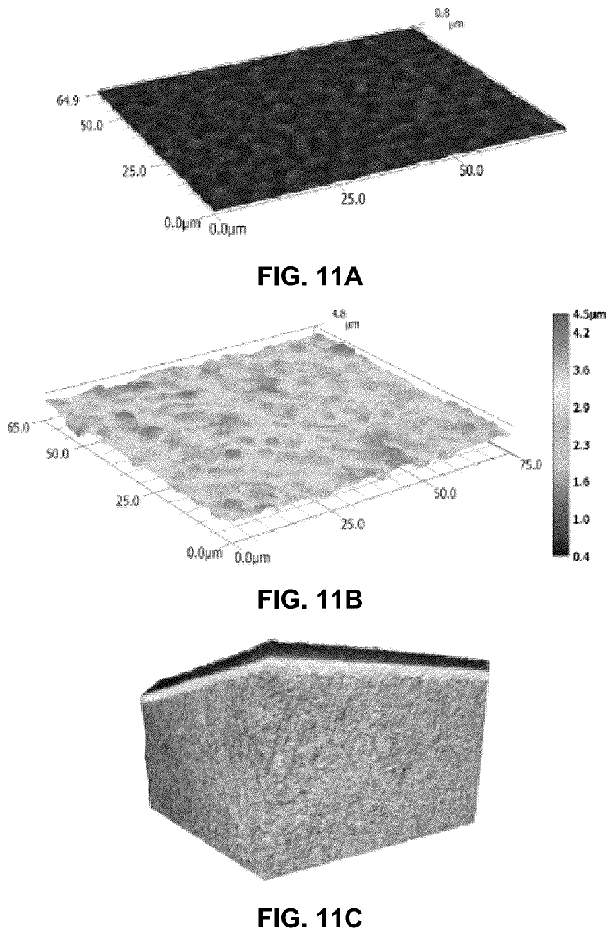

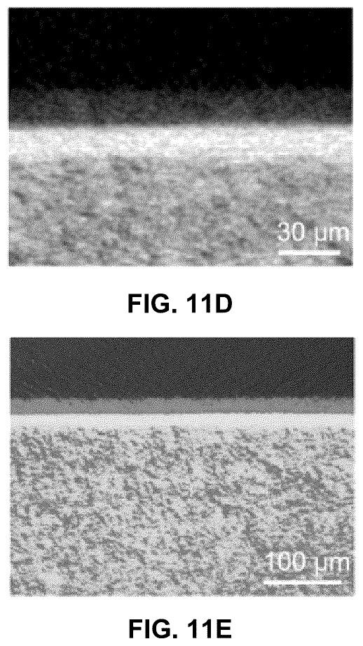

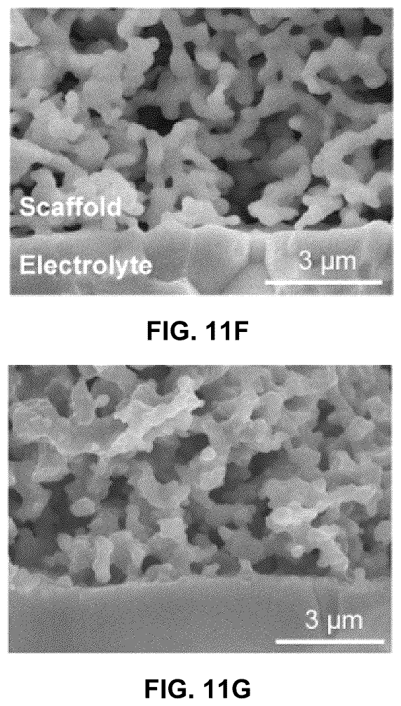

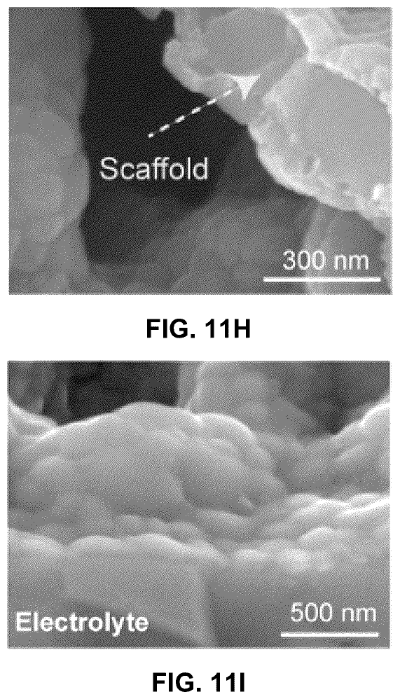

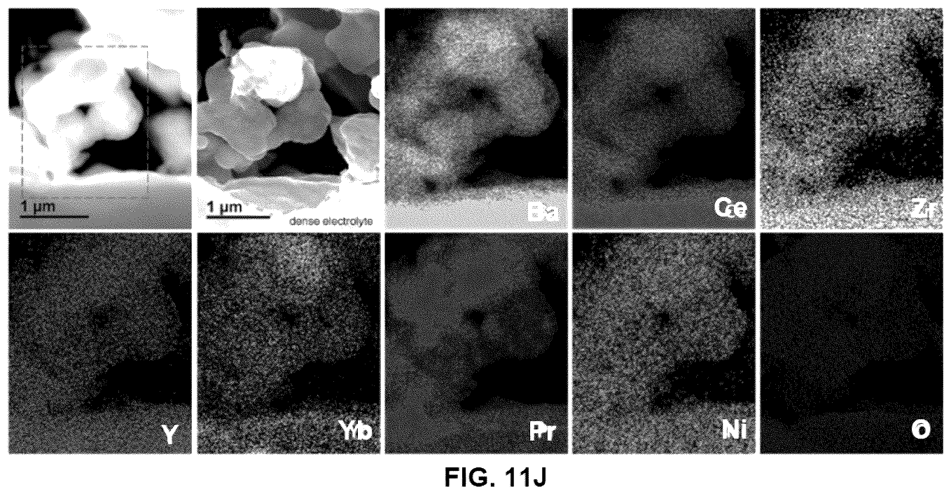

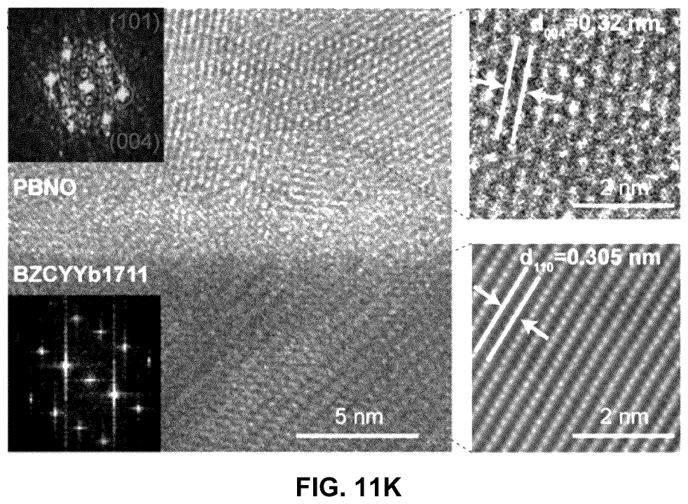

To address the issue of poor oxygen electrode-electrolyte interfacial contact in traditional screen-printed PC cells, the porous electrolyte scaffold composed of interconnected particles was bonded with the dense flat electrolyte. The morphologies of the flat electrolyte and porous scaffold are characterized. The dense electrolyte composed of coarse grains shows a relatively flat surface, leading to a mechanically weak electrode-electrolyte hetero-oxide bonding. Acid etching was reported to increase the surface roughness of sintered electrolyte and strengthen the electrode-electrolyte interfacial bonding. However, the etched electrolyte roughness was still limited to 0.77 μ m compared to the pasted electrode thickness (tens of micrometers). In contrast, the thickness of the porous and rough BZCYYb1711 scaffold over the flat electrolyte is ˜15 μ m. The three-dimensional (3D) digital microscope images (FIGS. 11A-11B) demonstrate the significantly increased roughness of the scaffold electrolyte compared to the flat counterpart. The 3D X-ray microscope (XRM) images (FIGS. 11C-11E) exhibit the upper BZCYYb1711 scaffold with a highly reticulated porous structure, middle dense BZCYYb1711 electrolyte layer and fairly porous NiO-BZCYYb1711 electrode layer. Scanning electron microscope (SEM) images show that the porous scaffold consisting of interconnected BZCYYb1711 particles is firmly bound with the dense electrolyte (FIG. 11F). The CCS sample retains the porosity after coated by PBNO, allowing for efficient gas transport and mass transfer (FIG. 11G). PBNO can be sintered at high temperatures to consolidate the electrode-electrolyte interfacial bonding without agglomeration and coarsening that occur in the PC cell. The core scaffold particles are conformally encapsulated by a continuous ˜100-nm-thick PBNO layer (FIG. 11H), and the top surface of flat electrolyte connected to the scaffold root is also fully covered (FIG. 11I).

The high-angle annular dark-field scanning transmission electron microscopy (HAADF-STEM) with energy-dispersive X-ray spectroscopy (EDX) mapping (FIG. 11J) and SEM-EDX mapping demonstrate that Ba, Zr, Ce, Y, and Yb are uniformly distributed in the electrolyte scaffold particles, while Pr, Ba, and Ni are nearly homogeneously distributed in the conformal coating layer. The PBNO/BZCYYb1711 interface is confirmed by high-resolution TEM (HRTEM), displaying their respective lattice fringes and fast-Fourier-transform (FFT) patterns (FIG. 11K). PBNO nanoparticles are sprinkled over the scaffold for the DCS, while PBNO particles are loosely connected with the dense electrolyte for the PC sample. The CCS pellet maintained the phase stability and surface morphology after treatment by 40% steam at 600° C. for 300 h, suggesting that the stable PBNO conformally and hermetically covered BZCYYb1711, effectively protecting BZCYYb1711 from steam-induced decomposition. In contrast, the DCS exhibited minor decomposition of BZCYYb1711 due to the incomplete surface coverage of PBNO.

### Symmetric Cell Performance

PBNO was found to have proton uptake capability and dual reactant (H₂O and O₂) dependency as a TCO electrode. The polarization resistances (Rₚ) and electrochemical stability of PBNO-based CCS, DCS and PC symmetric cells were examined in 40% steam at 600° C. The effects of graphite pore former percentages and scaffold particle sizes on the Rₚ of CCS were first investigated. The scaffold porosity is influenced by the content of pore former, and the optimal percentage is 40 wt. % leading to the minimum Rₚ. Rₚ grows with the increase of scaffold particle size and the lowest Rₚ of 0.12 Ωcm² is achieved using ˜300 nm BZCYYb1711 particles to construct the scaffold. The traditional PC cell fabrication procedures consist of pasting electrode powder onto the flat electrolyte where the properties of oxygen electrocatalyst such as grain size, porosity and mechanical strength are influenced by the complex powder synthesis and calcination processes. In stark contrast, the properties of CCS electrodes can be regulated by tuning the scaffold structures through controlling pore formers and unit particle sizes during the scaffold-electrolyte co-firing stage, as the conformal coating layer of oxygen electrocatalyst inherits from the structures and properties of the pre-sintered scaffold template. This method solves the dilemma between the delamination caused by the low-temperature calcination and porosity loss caused by the high-temperature coarsening.

The optimal CCS electrode shows a low Rₚ of 0.16 Ωcm² and high stability for 192 h with a minimal degradation rate (0.045% h⁻¹ or 7.1×10⁻⁵ Ωcm² h⁻¹) (Extended Data FIGS. 1c, d), as the PBNO conformal coating layer protects both the BZCYYb1711-scaffold backbone and dense electrolyte from the H₂O-induced phase decomposition. This Rp value is comparable to that of reported Co-rich active oxygen electrodes such as PrNi_{0.5}Co_{0.5}O_{3-δ} and PrBa_{0.8}Ca_{0.2}Co₂O_{5+δ}, but shows superior stability in 40% steam. The DCS electrode displays a lower initial Rₚ of 0.11 Ωcm² due to the increased active length of TPB but a higher degradation rate (0.45% h⁻¹ or 5×10⁻⁴ Ωcm² h⁻¹) owing to the insufficient surface coverage of PBNO on the scaffold. The composite air electrode by mixing PBNO and electrolyte particles shows a much higher degradation rate (0.3% h⁻¹ or 2.6×10⁻³ Ωcm² h⁻¹) due to the inevitable exposure of BZCYYb1711 to steam. In sharp contrast, the PC electrode delivers the highest Rp and degradation rate (3.44% h⁻¹ or 3.1×10⁻² Ωcm² h⁻¹) that are orders of magnitude higher than those of CCS. Therefore, the CCS can address the challenge of sluggish proton diffusion kinetics in the entire electrode layer (PC and composite) by using the porous highly conductive electrolyte scaffold as the skeleton with intimate PBNO electrode/scaffold interfacial contact and strong adhesion.

The post-mortem electrode/electrolyte interface morphologies (FIG. 9B) corroborate the superior stability of CCS that retains the intact conformal coating and unchanged surface and interface without segregation or exsolution, whereas the formation of secondary particles can be observed in DCS and PC electrodes. Particularly, the PC electrode shows the most rampant structure decomposition penetrating the dense electrolyte caused by the chemical instability of BZCYYb1711 in 40% H₂O. The thermomechanical stability of CCS was investigated, as the PCECs may subject to serious temperature fluctuations due to the intermittency of renewable energy sources and system startup. This has been rarely studied in prior PCEC works especially under rapid ramping/cooling rates. The thermal shock test of alternate fast heating and cooling substantiates the robustness and resilience of CCS, because the interfacial bonding of PBNO-BZCYYb1711 is strong in this design and the porous architecture can accommodate drastic volume changes and alleviate the stress/strain. Moreover, the TEC of PBNO is lower than that of Co-rich electrode materials and matches with that of BZCYYb1711. These factors contribute to the high thermal shock resistance and cycling stability of CCS and circumvent possible delamination.

### Fuel Cell Performance

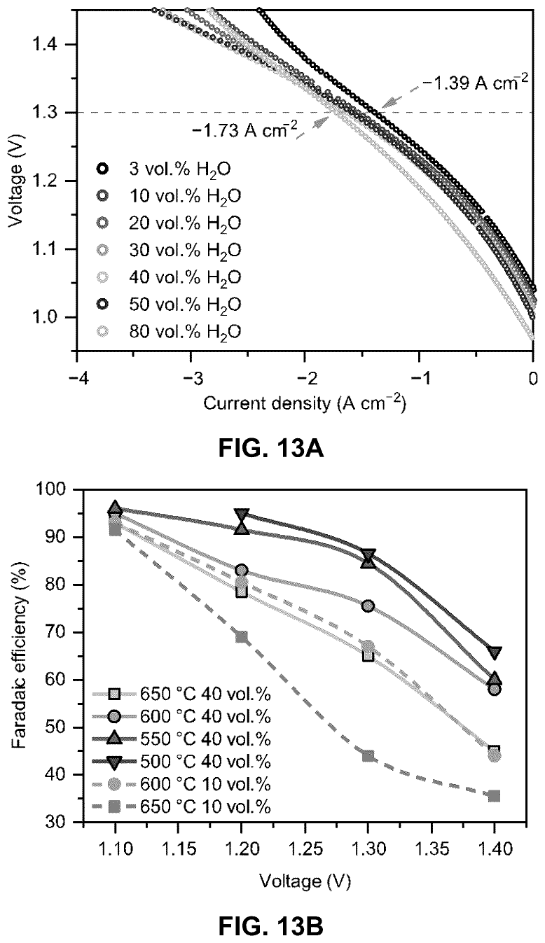

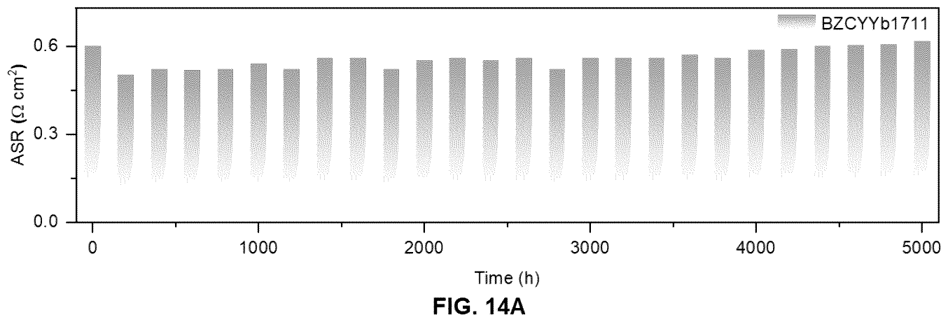

The electrochemical performances of CCS-based full cells were investigated under EC and FC modes. FIG. 5A shows the electrolysis polarization curves of CCS cell at 450-650° C. when the air electrode was fed with humidified air (5% H₂O). Under the fixed voltage, the current density grows with the increase of temperature. At 1.3 V, it delivers the current densities of −0.68, −1.46 and −2.4 A cm⁻² at 550, 600, and 650° C., respectively. The electrolysis performance outperforms that of many reported PCECs (FIG. 5B), and is comparable to that of promising PCECs with highly active Co-containing air electrodes. The increased H+O concentration in the feeding gas of air electrode enhances the electrolysis performance and Faradaic efficiency (FE) (FIGS. 13A-13B), indicating a high H₂O concentration is crucial to the industrial electrolysis. For example, the highest electrolysis current density of −1.73 A cm⁻² is achieved at 1.3 V and 600° C. in 80% H₂O. The CCS oxygen electrode dominates the Rₚ of full cell. Under the EC mode, the cell Rp significantly decreases and only accounts for 22-9% in the total resistance at 450-650° C., indicating the low interfacial impedance and high electrocatalytic OER activity of PBNO-BZCYYb1711 CCS design.

The FC performances of CCS cells were investigated (FIG. 5C), showing a peak power density of 181, 360, 629, 1160, and 1360 mW cm⁻² at 450, 500, 550, 600, and 650° C., respectively. The FC performance of CCS stands out among reported PCFCs with active Co-rich electrodes. Compared with the PC cell, the CCS cell demonstrates substantially improved performance, delivering 1.85 times higher electrolysis current density at 1.3 V and 2.7 times higher peak power density at 600° C. This suggests the advantages of CCS design in improving the interfacial contact, promoting the proton diffusion, and increasing the ECSA for enhancing the electrocatalytic activities and kinetics for OER and ORR. Unlike the UR-PEMFCs with a discontinuity around the open circuit voltage (OCV), the UR-PCEC shows a continuous polarization behavior across the OCV for switching between FC and EC modes, indicating high kinetic reversibility at high temperatures.1 The CCS-based UR-PCEC demonstrates a RTE of 69% at 1 A cm⁻² and 650° C. comparable to reported PCECs, but higher than common UR-PEMFCs (40-60%).

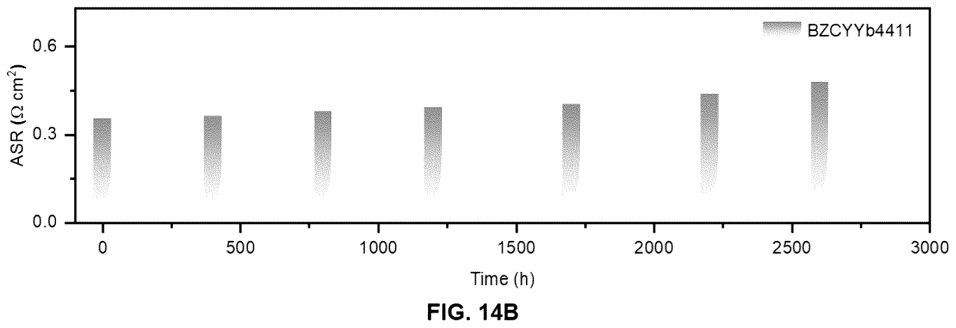

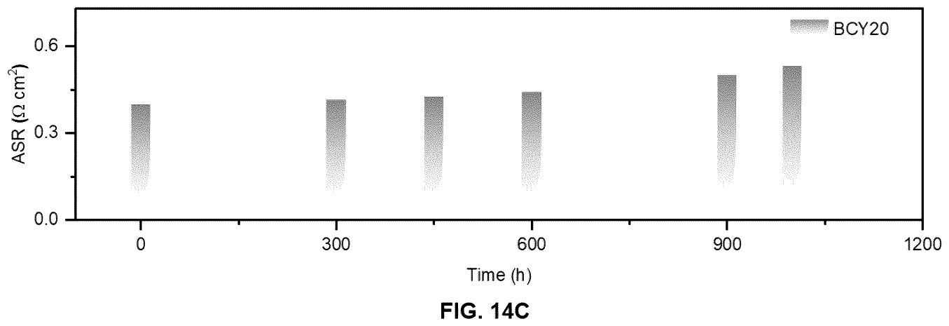

The long-term operational stability of PCECs in high-concentration steam remains a challenge that hinders their practical application. Motivated by the proven chemical stability of CCS, the long-term electrochemical stability of CCS-based PCECs was evaluated under harsh conditions. Under the FC mode conditions (0.4 A cm⁻² and 600° C.), the CCS-based cell demonstrates exceptional stability for 1000 h without degradation in wet air with 10% H₂O, while it exhibits a low degradation of 9 μV h⁻¹ for 760 h in humidified air with 20% H₂O (FIG. 5D). Under the EC mode, the PBNO-BZCYYb1711 CCS cell shows phenomenal electrolysis stability in 40% H₂O. It presents a low voltage degradation rate of 3 μV h⁻¹ at 500° C. (FIG. 5E), retaining a stable current density of −0.5 A cm⁻² for 1060 h. Above all, it exhibits unprecedentedly high electrolysis operational stability at −1.5 A cm⁻² and 600° C. for 5000 h (FIG. 5F), leading to an extremely low degradation rate of 1 μV h⁻¹. This is the best long-term electrolysis durability of PCECs to reach a record-high 5000-hour stability under such a high current density and steam concentration, representing a technological breakthrough towards highly stable PCECs. During the 5000-hour electrolysis, the CCS oxygen electrode showed remarkable impedance stability with an Rp degradation of merely 2.5×10⁻⁵ Ωcm² h⁻¹. Meanwhile, the impedance degradation of hydrogen electrode is negligible, resulting in high total resistance stability (FIGS. 14A-14C). The PBNO-BZCYYb1711 CCS cell even retains high electrolysis stability in 60% H₂O at −1.5 A cm⁻² and 600° C.

The CCS design strategy presented in this study is capable of stabilizing various proton-conducting electrolytes in high-concentration steam, making it a universal approach for PCECs that utilize multiple electrolytes. For instance, a PCEC composed of BZCYYb4411 electrolyte scaffold conformally coated by PBNO also shows a low degradation rate of 3 μV h⁻¹ at −1.0 A cm⁻² and 600° C. in 40% H₂O for 2600-hour electrolysis (FIG. 5F). This general approach can even effectively stabilize Zr-free BCY20 electrolyte scaffold which is one of the most vulnerable electrolytes in steam, displaying similar electrolysis durability for 1000 h. Their cell resistances also maintain prominent stability (FIGS. 14A-14C). By conformally coating the electrolyte scaffold with a stable oxygen electrocatalyst like PBNO, this approach makes the intrinsic chemical stability of proton-conducting electrolytes less strictly required, thus opening the possibility of designing conductivity-oriented proton conductors rather than balancing stability and conductivity. Compared to the state-of-the-art PCECs that show a notable degradation rate (>10 μV h⁻¹) in low-to-medium P_{H2O} and limited durability for tens to hundreds of hours, the CCS-based PCECs demonstrate extremely low degradation rates for EC and FC modes and record-high 5000-hour EC stability under harsh industrially relevant conditions (FIG. 5G).

The electrolysis stabilities of CCS, DCS, composite, and PC cells were compared under similar conditions (FIG. 5H). Both CCS and DCS show much lower voltages than composite and PC cells, showcasing the critical role of electrolyte scaffold in boosting the electrocatalytic activity and kinetics. More importantly, the degradation rate of CCS (7 μV h⁻¹) is dramatically lower than that of DCS (75 μV h⁻¹), composite (200 μV h⁻¹), and PC cells (1630 μV h⁻¹), substantiating the key role of conformal coating layer as a protective armor in suppressing the electrolyte decomposition in high-concentration steam. The Rₚ values of PC, DCS, and composite cells rapidly grow, suggesting the deteriorated interfaces and charge transfer. The morphologies of PBNO-BZCYYb1711 CCS electrodes after galvanostatic electrolysis for 300, 1000, and 5000 h in 40% H₂O were examined. Despite slight coarsening of the coating layer, the electrodes maintain high interfacial bonding between the BZCYYb1711 electrolyte (scaffold and dense part) and PBNO coating layer without delamination. The smooth crystal grains and clear grain boundaries of BZCYYb1711 are retained without decomposition, cracking, or exsolution. The robust interfacial bonding stability of PBNO-BZCYYb4411 CCS after 2600-hour electrolysis was also observed. In contrast, the DCS and PC electrodes exhibit apparent exsolution and electrolyte decomposition after electrolysis for 300 and 140 h, respectively. To uncover the role of stable PBNO coating layer in stabilizing the PCECs, PBSCF was used to replace PBNO in the CCS-based cell, delivering inferior electrochemical performances and stability.

The PBNO-BZCYYb1711 CCS cell also demonstrates outstanding thermomechanical stability against dramatic temperature change and maintains the electrolysis current stability during 6 cycles in the thermal shock testing (FIG. 5I), presenting salient robustness and resilience. The good thermomechanical strength can enable PCECs to adapt to rapid start-up and temperature fluctuation during operation. These results unequivocally prove that the CCS design approach can substantially enhance the performance, and electrochemical and thermomechanical stability of PCECs.

### Demonstration of CCS-Based UR-PCEC

Motivated by the proven outstanding performance of the CCS cell under EC and FC modes, a unitized regenerative PCEC (UR-PCEC) is demonstrated as an electrochemical energy conversion and storage system (FIG. 6A). First, the operation of UR-PCEC alternates between FC and EC modes at 600° C. with 40% H₂O-air and H₂ feeding in the air and hydrogen electrodes, respectively (FIG. 6E). The voltage responds instantly when the working mode is switched between FC and EC with an interval of 60 min. The voltage values under each mode are stable after 12 cycles without degradation. To validate its viability in practical applications for hydrogen and electricity generation, the CCS cell was integrated with H₂ circulation and storage functional auxiliary units to create a UR-PCEC prototype system which demonstrated the unitized regenerative self-sustainable operation without external H₂ supply under both frequent EC/FC alternation and harsh long-duration operation conditions. The EC and FC working modes of the UR-PCEC were alternated every 20 min at different current densities with the H₂ feeding solely from its EC process (FIGS. 6B-6D). Its voltage can immediately respond to each mode and get stabilized in a wide current range. Its reversible operation cycling stability is exceptional. For example, its EC and FC voltages at −0.9 and 0.45 A cm⁻² are even slightly improved after 24 cycles, respectively. The prompt response capability and cycling stability of the developed UR-PCEC under frequent and seamless switching conditions are crucial to the grid resilience enabling the timely dynamic response to power output fluctuations for leveling and smoothing the grid loads when the intermittent renewable energy sources are integrated. The cell OCV values with and without external H₂ feeding remain similar and stable during the cycles, indicating the excellent sealing and stability of UR-PCEC with a dense and impermeable ceramic electrolyte to eliminate the H₂/air crossover and self-discharge (gradual OCV loss) issue that can be found in UR-PEMFCs and batteries.

There is only one report on the PCEC demonstrating the self-sustainable operation under low H₂O concentration (10%) and frequent switching conditions (2-3 min interval), which showed apparent FC performance deterioration over 1.75 h. Most publications reported the shallow cycling of PCECs for EC/FC mode alternation every 2 h with the external H₂ feeding. Therefore, the operation of the disclosed UR-PCEC under long-duration deep cycling conditions is demonstrated without external H₂ supply to meet the practical requirements of electricity storage and supply towards a diurnal cycle. The UR-PCEC was operated under the EC mode at −1 A cm⁻² for 12 h representing the storage of electricity into H₂ fuel at the off-peak demand time, and then switched to the FC mode at 0.5 A cm⁻² for 12 h representing the electricity generation with the stored H₂ fuel at the on-peak demand time (FIG. 6G). Its alternate cycling operation was run over 13.5 days. The EC and FC voltages were stable and maintained at 1.21 and 0.86 V, respectively. Furthermore, the PCEC acts like an electrochemical compressor under EC mode and produces pure dry H₂ (slightly pressurized), requiring no further H2 purification/downstream separation and compression. The cycled UR-PCEC retains the entire structural integrity and stability for the scaffold/electrolyte, PBNO coating layer/scaffold, and electrode/electrolyte interfaces, rendering relatively high EIS impedance stability. In contrast, the DCS-based UR-PCEC exhibits slight voltage and impedance degradation after 96-hour cycling.

The energy conversion and storage capability of the UR-PCEC is evaluated by calculating its daily hydrogen production and electricity generation. The gross H₂ production and electrical energy output of the UR-PCEC at 600° C. in a day-night (12-12 h) cycle are 4080 mL cm⁻² and 5.16 Wh cm⁻², respectively. The PCEC can decouple the energy storage capacity with the rated power by freely tuning the H₂ storage system capacity and FC current density (output power). Therefore, the developed UR-PCEC is promising to effectively balance and smooth large variations between on and off-peak electricity demand and generation to provide peak-leveling and shaving functions and meanwhile has great potential as an energy system for seasonal energy storage and long-duration electricity discharge. The LCOH of the present CCS-based PCEC ($2.73 kg⁻¹) was estimated and found lower than that of reported O-SOC ($2.82 kg⁻¹) and PCECs with BaCo_{0.4}Fe_{0.4}Zr_{0.1}Y_{0.1}O_{3-δ} ($3.09 kg⁻¹) and PrBa_{0.2}Ca_{0.2}Co₂O_{5+δ} ($3.16 kg⁻¹) using a reported eco-technoeconomic analysis method.

Furthermore, the UR-PCEC can flexibly function for electrolysis of low-grade and saline water (e.g., seawater) without relying on the costly deionized water due to its use of H₂O vapor feeding. The polarization curves of the PCECs with deionized water and seawater vapor feeding almost overlap (FIG. 6H), showing high seawater electrolysis stability at −1 A cm⁻² for 210 h without impedance degradation. This provides a new approach to overcoming the technical challenges of PEM-based electrolyzers for direct liquid seawater electrolysis and reducing the cost of water purification.

### Multiscale and Multiphysics Modeling Computations

To elucidate the mechanistic insights into the OER activity enhancement of the CCS design compared to the PC one and unravel the roles of Ba dopant in PBNO electrocatalyst, multiscale and multiphysics modeling computations, including the computational fluid dynamic (CFD) simulations and density functional theory (DFT) calculations, were conducted. Models of CCS and PC were established with PBNO CCS of BZCYYb1711 and pure PBNO possessing the same particle size on the dense electrolyte, respectively. CFD simulations were performed for both models to understand the effect of microstructure design on the OER activity. PC and CCS were set as an equipotential and isopotential body to calculate the IR drop and Galvani potential, respectively. FIGS. 12A-12B show contour plots of the ionic (proton) current density distributions for two electrode designs at 1.3 V (EC mode). Their surface reaction rates were calculated. The PC electrode shows a traditional TPB reaction pattern, and its active region is limited to a sectorial domain with a length of 5 μ m from the electrolyte. In contrast, the CCS electrode shows an extended active length of ˜25 μ m, 5 times longer than PC. Furthermore, CCS shows a scaffold-facilitated conducting pattern, where protons generated from H2O dissociation on the PBNO-TCO surface tend to transfer through the TCO into the inner scaffold and then are transported into the bottom dense electrolyte via an integrated scaffold-electrolyte pathway. Therefore, CCS demonstrates a 3.3-time higher surface reaction rate in the vicinity of CCS/electrolyte interface than PC. This is due to the expedited proton transport in the scaffold bulk, which enables a large Galvani potential driving force. Thus, CCS delivers a lower equilibrium concentration of proton defects in PBNO than PC under the same bias, which facilitates the generation of proton defects from water dissociation and proton diffusion according to the Butler-Volmer equation, indicating a higher surface reaction rate.

The outer layers of PBNO for CCS and PC display a similar uniform growth pattern along the electrode, while a higher concentration gradient of proton defects in CCS renders a larger proton diffusion flux than PC. The inner layer (BZCYYb1711 scaffold) of CCS exhibits a distinct accelerated increase pattern of proton diffusion flux due to the Galvani potential-driven internal electric field in contrast to that (PBNO) of PC. Based on the microkinetic CFD simulations, the effects of grain particle diameter on the electrolysis polarization curves for PC and CCS are illustrated (FIG. 12C). The CCS design displays ≥1.94 times higher current densities than PC at 1.3 V. The electrolysis performance increases with the decrease of particle size. Here in the simulated grain size range, the highest simulated electrolysis performance is achieved with a grain size of ˜300 nm, which is consistent with the experimental polarization curve.

To gain insights into the effect of Ba dopant in PBNO on the surface hydration, the spin-polarized DFT calculation were performed using supercells from the tetragonal Ruddlesden-Popper phase to obtain the relative energies of proton defects in PBNO and Pr₂NiO_{4+δ} (PNO), 58 Note that an increase of the DFT-calculated slab energy indicates a less stable structure with the placed proton. A proton placed at the top surface layer of either (001) AO or (100) A₂BO₄ (A=Pr and Ba, B=Ni) surface with 25% Ba substitution for Pr, which is the most stable slab structure, is taken as a reference (FIG. 12D). When a proton is placed at the bottom layer without Ba (representing the PNO scenario), the slab energy is higher than that at the top surface layer (reference state) with Ba (representing the PBNO case), suggesting the less stable slab structure for PNO. Since the relative slab stability is a proton affinity indicator relevant to water dissociative incorporation into the defective lattice, the relatively higher slab stability of PBNO compared to the PNO surface indicates the promoted water hydration for PBNO. The proton affinity decreases (slab energy grows), as the proton approaches the middle region of the slab models. This different behavior may originate from the different coordination between the surface and bulk.

To further verify the effect of Ba doping on increasing the proton affinity, the total electronic density-of-state (DOS) analysis was performed to analyze the electronic structure (FIG. 12E). The introduction of Ba dopant can create holes. When the Fermi levels are set at 0 for both PBNO and PNO, the band features of PBNO are shifted towards a higher energy. Therefore, the introduced holes and increased basicity upon Ba doping result in enhanced interaction between PBNO and proton as well as related intermediates (e.g., OH and O), which benefits the hydration process. The DFT results reveal that the Ba dopant can enhance the surface hydration capability of PBNO. Combining the DFT calculation results, microkinetic CFD simulations were iteratively performed to reveal the effect of the surface hydration on the electrolysis performance. FIG. 12F illustrates the improvement of electrolysis polarization curves when the relative hydration capability is increased from 1/16 to 3/2 of the baseline value, where the current density substantially grows from −1.03 to −1.52 A cm⁻² at 1.3 V.

In addition to enhancing the surface hydration capability, it is hypothesized that Ba doping can also promote the proton diffusivity in PBNO. The ab initio molecular dynamics (AIMD) simulations were carried out for a dissociated H₂O in bulk PBNO forming proton defects in separated rock-salt layers. As shown in FIG. 12G, the trajectory of a proton adjacent to an interstitial O (as an OH interstitial pair with a bond length of ˜1 Å or forming a hydrogen bond with the interstitial O) is more confined in proximity, whereas a proton without a nearby interstitial O travels more freely from one apical oxygen to another apical oxygen (across the rock-salt layer). Thus, the interstitial O may potentially act as a trapping defect for the incorporated protons. This proton trapping effect near an interstitial O is further supported by the proton stability analysis of Pr₁₄Ba₂Ni₈O₃₃H₁ supercell with a proton at various interstitial locations, where the relative stability of proton adjacent to an interstitial O (distance of 1.0-1.5 Å from the interstitial O) is higher than that of proton near an apical lattice O away from the interstitial O. This indicates a stronger binding between the proton and interstitial O. For comparison, a proton in Pr₁₄Ba₂Ni₈O₃₂H₁ supercell has several similar stable configurations where protons are bonded with apical oxygens. Given the trapping effect imposed on protons near interstitial oxygen, Ba doping is likely beneficial to the proton transport in the PNO family, as 20% Ba doping can decrease the interstitial oxygen (proton trap) concentration from 0.256 to 0.097 and hence may increase the proton conductivity and diffusivity in the bulk.

Combining the DFT calculation results, microkinetic CFD simulations were further performed to unravel the influence of the proton diffusivity on the electrolysis performance. FIG. 12H illustrates the enhancement of electrolysis polarization curves when the relative proton diffusivity is increased from 1/16 to 3/2 of the baseline value, where the current density rises from −1.13 to −1.56 A cm⁻² at 1.3 V. Both the DFT and CFD simulation results suggest the improved electrolysis performance of PBNO over PNO. Despite their similar Rₚ, the CCS-based PCEC with PBNO as the oxygen electrocatalyst presents a higher electrolysis performance than that with PNO, where the current density of PBNO is 1.7 times higher than that of PNO at 1.3 V. This experimental result is consistent with the simulation results. In short, the CCS microstructure design establishes the percolated proton conducting network, which extends the active length from the TPB of PC electrode/electrolyte interface to the electrode bulk and significantly increases the ECSA. Abundant electrode/electrolyte contact interfaces in CCS tend to enhance the diffusion kinetics and ensure fast proton transfer and migration through the diffusion pathway within the thin TCO electrode coating layer. The proton fluxes generated from the TCO-based OER electrocatalyst can converge to the conductive scaffold backbone to accelerate proton transfer and migration. Ba doping plays multiple key roles in enhancing the surface hydration/protonation, decreasing the interstitial O (proton trap) concentration, and boosting the proton diffusivity. Therefore, the CCS microstructure and PBNO collectively contribute to the enhanced electrolysis performance.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Azimova, M. A.; et al. Properties and Performance of Anode-Supported Proton-Conducting BaCe_{0.48}Zr_{0.4}Yb_{0.1}Co_{0.02}O_{3-δ} Solid Oxide Fuel Cells. Journal of the Electrochemical Society 2010, 157 (10), B1397.
2. Baniecki, J. D.; et al. Chemisorption of water and carbon dioxide on nanostructured BaTiO₃-SrTiO₃ (001) surfaces. Journal of Applied Physics 2009, 106 (5), 054109.
3. Bhide, S. V.; et al. Stability of BaCeO₃-based proton conductors in water-containing atmospheres. Journal of The Electrochemical Society 1999, 146 (6), 2038.
4. Bian, W. et al. Revitalizing interface in protonic ceramic cells by acid etch. Nature 604, 479-485 (2022).
5. Brookes, N. B.; et al. SrTiO₃(100) Step Sites as Catalytic Centers for H₂O Dissociation. Solid State Commun 1987, 64 (3), 383-386.
6. Cheng, Y.; et al. Enhancing Oxygen Exchange Activity by Tailoring Perovskite Surfaces. The journal of physical chemistry letters 2019, 10 (14), 4082-4088.
7. Choi, M. et al. Exceptionally high performance of protonic ceramic fuel cells with stoichiometric electrolytes. Energy Environ. Sci. 14, 6476-6483 (2021).
8. Choi, S., et al. Protonic ceramic electrochemical cells for hydrogen production and electricity generation: Exceptional reversibility, stability, and demonstrated faradaic efficiency. Energy Environ. Sci. 12, 206-215 (2019).
9. Ding, D.; et al. Enhancing SOFC cathode performance by surface modification through infiltration. Energy & Environmental Science 2014, 7 (2), 552-575.
10. Ding, H. et al. Self-sustainable protonic ceramic electrochemical cells using a triple conducting electrode for hydrogen and power production. Nat. Commun. 11, 1907 (2020).
11. Duan, C.; et al. Highly efficient reversible protonic ceramic electrochemical cells for power generation and fuel production. Nat. Energy 2019, 4 (3), 230-240.
12. Duan, C. et al. Highly durable, coking and sulfur tolerant, fuel-flexible protonic ceramic fuel cells. Nature 557, 217-222 (2018).
13. Duan, C., et al. Proton-conducting oxides for energy conversion and storage. Appl. Phys. Rev. 7, 011314 (2020).
14. Duan, C. et al. Readily processed protonic ceramic fuel cells with high performance at low temperatures. Science 349, 1321-1326 (2015).
15. Dubois, A.; et al. Benchmarking the expected stack manufacturing cost of next generation, intermediate-temperature protonic ceramic fuel cells with solid oxide fuel cell technology. J. Power Sources 2017, 369, 65-77.
16. Ebbesen, S. D.; et al. High temperature electrolysis in alkaline cells, solid proton conducting cells, and solid oxide cells. Chem Rev 2014, 114 (21), 10697-734.
17. Fabbri, E.; et al. Tailoring the chemical stability of Ba (Ce_{0.8-x}Zrₓ)Y_{0.2}O_{3-δ} protonic conductors for intermediate temperature solid oxide fuel cells (IT-SOFCs). Solid State Ionics 2008, 179 (15-16), 558-564.
18. Fan, L.; et al. Layer-structured LiNi_{0.8}Co_{0.2}O₂: A new triple (H⁺/O²⁻/e⁻) conducting cathode for low temperature proton conducting solid oxide fuel cells. J. Power Sources 2016, 306, 369-377.
19. Grimaud, A.; et al. Hydration and transport properties of the Pr₂₋ₓSr_{X}NiO_{4+δ} compounds as H⁺-SOFC cathodes. J. Mater. Chem. 2012, 22 (31), 16017-16025.
20. Guan, B.; et al. A Performance Study of Solid Oxide Fuel Cells With BaZr_{0.1}Ce_{0.7}Y_{0.2}O_{3-δ} Electrolyte Developed by Spray-Modified Pressing Method. Fuel Cells 2012, 12 (1), 141-145.
21. Gür, T. M. Review of electrical energy storage technologies, materials and systems: Challenges and prospects for large-scale grid storage. Energy Environ. Sci. 11, 2696-2767 (2018).
22. He, F. et al. Catalytic self-assembled air electrode for highly active and durable reversible protonic ceramic electrochemical cells. Adv. Funct. Mater. 32, 2206756 (2022).
23. He, F. et al. An efficient high-entropy perovskite-type air electrode for reversible oxygen reduction and water splitting in protonic ceramic cells. Adv. Mater. 35, 2209469 (2023).
24. He, F. et al. A surface reconfiguration of a perovskite air electrode enables an active and durable reversible protonic ceramic electrochemical cell. Energy Storage Mater. 53, 754-762 (2022).
25. Hengerer, R.; et al. Orientation Dependence of Charge-Transfer Processes on TiO₂ (Anatase) Single Crystals. Journal of The Electrochemical Society 2000, 147 (4), 1467-1472.
26. Henrich, V. E.; et al. The surface science of metal oxides, Cambridge university press: 1996.
27. Jingde, L.; et al. Chemical stability of doped BaCeO₃-BaZrO₃ solid solutions in different atmospheres. Journal of Rare Earths 2008, 26 (4), 505-510.
28. Kim, D. et al. High-performance protonic ceramic electrochemical cells. ACS Energy Lett. 7, 2393-2400 (2022).
29. Kim, H. et al. Unveiling the key factor for the phase reconstruction and exsolved metallic particle distribution in perovskites. Nat. Commun. 12, 6814 (2021).
30. Kim, J. et al. Triple-conducting layered perovskites as cathode materials for proton-conducting solid oxide fuel cells. ChemSusChem 7, 2811-2815 (2014).
31. Kurtz, R. L.; et al. Synchrotron Radiation Studies of H₂O Adsorption on TiO₂(110). Surf Sci 1989, 218 (1), 178-200.
32. Lee, Y.-L. et al. Defect thermodynamics and transport properties of proton conducting oxide BaZr1−xYxO3−δ (x≤0.1) guided by density functional theory modeling. JOM 74, 4506-4526 (2022).
33. Lee, Y.-L. et al. Kinetics of oxygen surface exchange on epitaxial ruddlesden-popper phases and correlations to first-principles descriptors. J. Phys. Chem. Lett. 7, 244-249 (2016).
34. Lei, L. et al. Progress report on proton conducting solid oxide electrolysis cells. Adv. Funct. Mater. 29, 1903805 (2019).
35. Li, W. et al. High performing triple-conductive Pr₂NiO_{4+δ} anode for proton-conducting steam solid oxide electrolysis cell. J. Mater. Chem. A 2018, 6 (37), 18057-18066.
36. Li, W. et al. Layer-structured triple-conducting electrocatalyst for water-splitting in protonic ceramic electrolysis cells: Conductivities vs. activity. Journal of Power Sources 2021, 495, 229764.
37. Li, W. et al. Low-temperature water electrolysis: Fundamentals, progress, and new strategies. Mater. Adv. 3, 5598-5644 (2022).
38. Li, W.; Synergistic Coupling of Proton Conductors BaZr_{0.1}Ce_{0.7}Y_{0.1}Yb_{0.1}O_{3-δ} and La₂Ce₂O₇ to Create Chemical Stable, Interface Active Electrolyte for Steam Electrolysis Cells. ACS applied materials & interfaces 2019, 11 (20), 18323-18330.
39. Li, W.; et al. Enhanced surface exchange activity and electrode performance of (La₂₋₂ₓSr₂ₓ)(Ni₁₋ₓMnₓ) O_{4+δ} cathode for intermediate temperature solid oxide fuel cells. J. Power Sources 2016, 318, 178-183.
40. Li, W.; et al. Synergistic Coupling of Proton Conductors BaZr_{0.1}Ce_{0.7}Y_{0.1}Yb_{0.1}O_{3-δ} and La₂Ce₂O₇ to Create Chemical Stable, Interface Active Electrolyte for Steam Electrolysis Cells. ACS Appl. Mater. Interfaces 2019, 11 (20), 18323-18330.
41. Liang, M. et al. A new durable surface nanoparticles-modified perovskite cathode for protonic ceramic fuel cells from selective cation exsolution under oxidizing atmosphere. Adv. Mater. 34, 2106379 (2022).
42. Liang, M. et al. High-temperature water oxidation activity of a perovskite-based nanocomposite towards application as air electrode in reversible protonic ceramic cells. Appl. Catal. B 331, 122682 (2023).
43. Liu, X.-M. et al. Electrical conductivity and chemical stability of BaCe_{0.8-x}AₓGd_{0.2}O_{3-δ} (A=In, Zr, Ta; x=0, 0.1) ceramics. Bulletin of Materials Science 2013, 36 (3), 395-401.
44. Løken, A.; et al. Thermal and chemical expansion in proton ceramic electrolytes and compatible electrodes. Crystals 2018, 8 (9), 365.
45. Luo, Z. Y. et al. Critical role of acceptor dopants in designing highly stable and compatible proton-conducting electrolytes for reversible solid oxide cells. Energy Environ. Sci. 15, 2992-3003 (2022).
46. Luo, Z. et al. A new class of proton conductors with dramatically enhanced stability and high conductivity for reversible solid oxide cells. Small 19, 2208064 (2023).
47. Luo, Z. Y. et al. Highly conductive and durable Nb(Ta)-doped proton conductors for reversible solid oxide cells. ACS Energy Lett. 7, 2970-2978 (2022).
48. Matsuzaki, Y.; et al. Effect of proton-conduction in electrolyte on electric efficiency of multi-stage solid oxide fuel cells. Sci. Rep. 2015, 5 (1), 1-10.
49. Mebane, D. S., et al. A two-dimensional model and numerical treatment for mixed conducting thin films: The effect of sheet resistance. J. Electrochem. Soc. 154, A421 (2007).
50. Murphy, R. et al. A new family of proton-conducting electrolytes for reversible solid oxide cells: BaHfₓCe_{0.8-x}Y_{0.1}Yb_{0.1}O_{3-δ}. Adv. Funct. Mater. 30, 2002265 (2020).
51. Naeini, M., et al. An eco-technoeconomic analysis of hydrogen production using solid oxide electrolysis cells that accounts for long-term degradation. Front. Energy Res. 10, 1015465 (2022).
52. Niu, Y. H. et al. Highly active and durable air electrodes for reversible protonic ceramic electrochemical cells enabled by an efficient bifunctional catalyst. Adv. Energy Mater. 12, 2103783 (2022).
53. Park, K. et al. Understanding the highly electrocatalytic active mixed triple conducting NaₓCa₃₋ₓCo4O_{9-δ} oxygen electrode materials. Adv. Energy Mater. 13, 2202999 (2023).
54. Pasierb, P.; et al. Chemical stability of Ba(Ce₁₋ₓTiₓ)_{1-y}Y_{y}O₃ proton-conducting solid electrolytes. Journal of thermal analysis and calorimetry 2009, 96 (2), 475-480.
55. Pei, K. et al. Surface restructuring of a perovskite-type air electrode for reversible protonic ceramic electrochemical cells. Nat. Commun. 13, 2207 (2022).
56. Pei, K. et al. Constructing an active and stable oxygen electrode surface for reversible protonic ceramic electrochemical cells. Appl. Catal. B 330, 122601 (2023).
57. Pellow, M. A., et al. Hydrogen or batteries for grid storage? A net energy analysis. Energy Environ. Sci. 8, 1938-1952 (2015).
58. Peng, X. et al. Hierarchical electrode design of highly efficient and stable unitized regenerative fuel cells (URFCs) for long-term energy storage. Energy Environ. Sci. 13, 4872-4881 (2020).
59. Regmi, Y. N. et al. A low temperature unitized regenerative fuel cell realizing 60% round trip efficiency and 10 000 cycles of durability for energy storage applications. Energy Environ. Sci. 13, 2096-2105 (2020).
60. Ryu, K. H.; et al. Chemical stability and proton conductivity of doped BaCeO₃-BaZrO₃ solid solutions. Solid State Ionics 1999, 125 (1-4), 355-367.
61. Saqib, M. et al. Modification of oxygen-ionic transport barrier of BaCo0.4Zr0.1Fe0.4Y0.1O3 steam (air) electrode by impregnating samarium-doped ceria nanoparticles for proton-conducting reversible solid oxide cells. J. Electrochem. Soc. 166, F746 (2019).
62. Saqib, M. et al. Transition from perovskite to misfit-layered structure materials: A highly oxygen deficient and stable oxygen electrode catalyst. Energy Environ. Sci. 14, 2472-2484 (2021).
63. Shi, H. et al. Building ruddlesden-popper and single perovskite nanocomposites: A new strategy to develop high-performance cathode for protonic ceramic fuel cells. Small 17, 2101872 (2021).
64. Song, Y. et al. Nanocomposites: A new opportunity for developing highly active and durable bifunctional air electrodes for reversible protonic ceramic cells. Adv. Energy Mater. 11, 2101899 (2021).
65. Song, Y. et al. Self-assembled triple-conducting nanocomposite as a superior protonic ceramic fuel cell cathode. Joule 3, 2842-2853 (2019).
66. Su, H., et al. Degradation issues and stabilization strategies of protonic ceramic electrolysis cells for steam electrolysis. Energy Sci. Eng. 10, 1706-1725 (2022).
67. Sun, C. et al. Tailoring a micro-nanostructured electrolyte-oxygen electrode interface for proton-conducting reversible solid oxide cells. J. Power Sources 449, 227498 (2020).
68. Tanner, C. W.; et al. Instability of BaCeO₃ in H₂O-Containing Atmospheres. Journal of The Electrochemical Society 1996, 143 (4), 1386.
69. Tarutina, L. R., et al. Electrochemical activity of original and infiltrated Fe-doped Ba(Ce,Zr,Y)O₃-based electrodes to be used for protonic ceramic fuel cells. Catalysts 12, 1421 (2022).
70. Thomas, A. G.; et al. Soft-X-Ray Photon-Stimulated Ion Desorption from Srtio3(100)-H2o. Surf Sci 1994, 307, 355-359.
71. Tian, H.; et al. Deconvolution of Water-Splitting on the Triple-Conducting Ruddlesden-Popper-Phase Anode for Protonic Ceramic Electrolysis Cells. ACS Applied Materials & Interfaces 2020, 12 (44), 49574-49585.
72. Tian, H. et al. Protonic ceramic materials for clean and sustainable energy: Advantages and challenges. Int. Mater. Rev. 68, 272-300 (2023).
73. Tong, H., et al. A novel self-assembled cobalt-free perovskite composite cathode with triple-conduction for intermediate proton-conducting solid oxide fuel cells. Adv. Funct. Mater. 32, 2209695 (2022).
74. Tong, W. et al. Electrolysis of low-grade and saline surface water. Nat. Energy 5, 367-377 (2020).
75. Upasen, S.; et al. Protonation and structural/chemical stability of Ln₂NiO_{4+δ} ceramics vs. H2O/CO2: High temperature/water pressure ageing tests. Journal of Alloys and Compounds 2015, 622, 1074-1085.
76. Upasen, S.; et al. Protonation and structural/chemical stability of Ln₂NiO_{4+δ} ceramics vs. H₂O/CO₂: High temperature/water pressure ageing tests. Journal of Alloys and Compounds 2015, 622, 1074-1085.
77. Vollestad, E. et al. Mixed proton and electron conducting double perovskite anodes for stable and efficient tubular proton ceramic electrolysers. Nat. Mater. 18, 752-759 (2019).
78. Wang, N. et al. Machine-learning-accelerated development of efficient mixed protonic-electronic conducting oxides as the air electrodes for protonic ceramic cells. Adv. Mater. 34, 2203446 (2022).
79. Wang, Y., et al. A review on unitized regenerative fuel cell technologies, part-A: Unitized regenerative proton exchange membrane fuel cells. Renew. Sust. Energ. Rev. 65, 961-977 (2016).
80. Wang, Y., et al. A review on unitized regenerative fuel cell technologies, part B: Unitized regenerative alkaline fuel cell, solid oxide fuel cell, and microfluidic fuel cell. Renew. Sust. Energ. Rev. 75, 775-795 (2017).
81. Wu, W. et al. 3D self-architectured steam electrode enabled efficient and durable hydrogen production in a proton-conducting solid oxide electrolysis cell at temperatures lower than 600° C. Adv. Sci. 5, 1800360 (2018).
82. Xu, K. et al. An efficient steam-induced heterostructured air electrode for protonic ceramic electrochemical cells. Adv. Funct. Mater. 32, 2110998 (2022).
83. Yan, R.; et al. A stable BaCeO₃-based proton conductor for solid oxide fuel cells. Ionics 2009, 15 (6), 749.
84. Zan, J. et al. Characterization and functional application of PrBa0.5Sr0.5Co1.5Fe0.5O5+δ cathode material for it-sofc. Mater. Res. Bull. 137, 111173 (2021).
85. Zhang, W. et al. Water electrolysis toward elevated temperature: Advances, challenges and frontiers. Chem. Rev. 123, 7119-7192 (2023).
86. Zhou, C.; et al. New reduced-temperature ceramic fuel cells with dual-ion conducting electrolyte and triple-conducting double perovskite cathode. J. Mater. Chem. A 2019, 7 (21), 13265-13274.
87. Zhou, X.; et al. Ionic conductivity, sintering and thermal expansion behaviors of mixed ion conductor BaZr_{0.1}Ce_{0.7}Y_{0.1}Yb_{0.1}O_{3-δ} prepared by ethylene diamine tetraacetic acid assisted glycine nitrate process. Journal of Power Sources 2011, 196 (11), 5000-5006.
88. Zhou, Y.; et al. An Active and Robust Air Electrode for Reversible Protonic Ceramic Electrochemical Cells. ACS Energy Letters 2021, 6, 1511-1520.
89. Zhou, Y. C. et al. An efficient bifunctional air electrode for reversible protonic ceramic electrochemical cells. Adv. Funct. Mater. 31, 2105386 (2021).
90. Zohourian, R.; et al. Mixed-Conducting Perovskites as Cathode Materials for Protonic Ceramic Fuel Cells: Understanding the Trends in Proton Uptake. Advanced Functional Materials 2018, 28 (35), 1801241.
91. Zou, J. et al. Electrochemical compression technologies for high-pressure hydrogen: Current status, challenges and perspective. Electrochem. Energy Rev. 3, 690-729 (2020).
92. Zvonareva, I., et al. Electrochemistry and energy conversion features of protonic ceramic cells with mixed ionic-electronic electrolytes. Energy Environ. Sci. 15, 439-465 (2022).

What is claimed is:

1. A conformal coating scaffold electrode comprising a sintered perovskite mesh scaffold and a conformal catalyst coating.

2. The conformal coating scaffold electrode of claim 1, wherein the sintered perovskite mesh scaffold comprises BaZrₓCe_{y}Y_{z}Yb_{(1-x-y-z)}O_{3-δ}, wherein 0.1≤x≤0.8, wherein 0≤y≤0.8, and wherein 0≤z≤0.3.

3. The conformal coating scaffold electrode of claim 1, wherein the sintered perovskite mesh scaffold comprises BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), or a combination thereof.

4. The conformal coating scaffold electrode of claim 1, wherein the conformal catalyst coating comprises Pr₂₋ₓBaₓNiO_{4+δ}, wherein 0≤x≤0.4.

5. The conformal coating scaffold electrode of claim 1, wherein the conformal catalyst coating comprises Pr_{1.8}Ba_{0.2}NiO_{4.1} (PBNO).

6. The conformal coating scaffold electrode of claim 1 wherein the catalyst coating forms a continuous, uniform film over the scaffold.

7. The conformal coating scaffold electrode of claim 6, wherein the film is from about 20 nm to about 200 nm.

8. A symmetrical cell comprising the conformal coating scaffold electrode of claim 1.

9. The symmetrical cell of claim 8, wherein the symmetrical cell has a polarization resistance less than about 0.2 Ω·cm².

10. The symmetrical cell of claim 8, wherein a final polarization resistance after 200 hours of operation is no more than about 10% greater than an initial polarization resistance.

11. The symmetrical cell of claim 8, wherein the initial polarization resistance and the final polarization resistance are measured in an environment containing from about 30 vol % to about 60 vol % H₂O in air.

12. The symmetrical cell of claim 8, wherein operation comprises repeated thermal cycles from a first temperature to a second temperature and back to the first temperature.

13. The symmetrical cell of claim 12, wherein the first temperature is about 100° C. and the second temperature is from about 600 to about 750° C.

14. A single electrochemical cell comprising the conformal coating scaffold electrode of claim 1.

15. The single electrochemical cell of claim 14, further comprising a fuel electrode support.

16. The single electrochemical cell of claim 15, wherein the fuel electrode support comprises NiO, one or more perovskite precursors, and a pore former.

17. The single electrochemical cell of claim 16, wherein the one or more perovskite precursors comprise Ba, Ce, Zr, Y, and Yb (BZCYYb).

18. The single electrochemical cell of claim 17, wherein the NiO, the BZCYYb, and the pore former are present in a ratio of about 5:5:2 by weight.

19. A device comprising the symmetrical cell of claim 1.

20. The device of claim 19, wherein the device comprises a fuel cell or an electrolysis cell.
